(19) United States
(12) Patent Application Publication
(10) Pub. No.: US 2024/0235760 A1
(43) Pub. Date: Jul. 11, 2024

(54) METHODS AND NODES FOR IMR AND CMR ASSOCIATION FOR NCJT

(71) Applicant: TELEFONAKTIEBOLAGET LM ERICSSON (PUBL), Stockholm (SE)

(72) Inventors: ANDREAS NILSSON, GÖTEBORG (SE); SIVA MURUGANATHAN, STITTSVILLE (CA); SHIWEI GAO, NEPEAN (CA); HELKA-LIINA MÄÄTTÄNEN, ESPOO (FI)

(21) Appl. No.: 18/558,407

(22) PCT Filed: May 11, 2022
(86) PCT No.: PCT/IB2022/054392

§ 371 Date: Nov. 1, 2023

Related U.S. Application Data
(60) Provisional application No. 63/187,100, filed on May 11, 2021.

(51) Int. Cl. H04L 5/00; H04W 72/541

(52) U.S. Cl. CPC H04L 5/0048; H04L 5/0035; H04W 72/541

(57) ABSTRACT

There is provided a method performed by a UE for performing a plurality of CSI measurements for CSI reporting, wherein at least a first of the plurality of CSI measurements is based on a single CSI-RS resource and at least a second of the plurality of CSI measurements is based on a pair of CSI-RS resources, the UE being configured with a set of CMRs and a set of IMRs. The method may comprise: obtaining a configuration including an indication of: a first number (M) of resources in the set of CMRs for performing the first CSI measurement, a second number (N) of resource pairs from the set of CMRs for performing the second CSI measurement, a third number of resources in the set of IMRs, and an association between the resources in the set of CMRs and the resources in the set of IMRs, based on a first ordering of the M resources in the set of CMRs and in the set of IMRs and based on a second ordering of the N resource pairs in the set of CMRs and the N resources in the set of IMRs; and performing CSI measurements based at least on the obtained configuration.

### RELATED APPLICATIONS

This application claims the benefit of and priority to U.S. Provisional Patent Application No. 63/187,100, filed May 11, 2021, entitled “Framework for IMR and CMR association for NCJT”, the disclosure of which is incorporated herein by reference in its entirety.

### FIELD

The description generally relates to wireless communication systems and more specifically to methods and nodes for handling IMR and CMR association for NCJT.

### BACKGROUND

New Radio (NR) uses Cyclic Prefix Orthogonal Frequency Division Multiplexing (CP-OFDM) in both downlink (DL), i.e. from a network node, gNB or base station, to a user equipment (UE), and uplink (UL), i.e. from the UE to the gNB. Discrete Fournier Transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is shown in FIG. 1 with a 14-symbol slot, where the first two symbols contain physical downlink control channel (PDCCH) and the rest contains physical shared data channel, either PDSCH (physical downlink shared channel) or PUSCH (physical uplink shared channel).

Different subcarrier spacing values are supported in NR. The supported subcarrier spacing values (also referred to as different numerologies) are given by Δf=(15×2^{μ}) kHz where μ∈{0,1,2,3,4}. Δf=15 kHz is the basic subcarrier spacing. The slot durations at different subcarrier spacings is given by ½^{μ} ms.

In the frequency domain, a system bandwidth is divided into resource blocks (RBs), each corresponds to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

### Channel State Information (CSI) and CSI Feedback

A core component in Long Term Evolution (LTE) and NR is the support of Multiple Input Multiple Output (MIMO) antenna deployments and MIMO related techniques. Spatial multiplexing is one of the MIMO techniques used to achieve high data rates in favorable channel conditions.

For an antenna array with NT antenna ports at the gNB for transmitting r DL symbols s=[s₁, s₂, . . . , sᵣ]^{T}, the received signal at a UE with N_{R} receive antennas at a certain RE n can be expressed as

$${y}_{n} = {H}_{n} Ws + {e}_{n}$$

where yₙ is a N_{R}×1 received signal vector; Hₙ a N_{R}×N_{T} channel matrix at the RE between the gNB and the UE; W is an NT×r precoder matrix; eₙ is a N_{R}×1 noise plus interference vector received at the RE by the UE. The precoder W can be a wideband precoder, i.e., constant over a whole bandwidth part (BWP), or a subband precoder, i.e. constant over each subband.

The precoder matrix is selected from a codebook of possible precoder matrices, and reported by a precoder matrix indicator (PMI), which specifies a unique precoder matrix in the codebook for a given number of symbol streams. Each of the r symbols in s corresponds to a spatial layer. r is referred to as the rank of the channel and is reported by a rank indicator (RI).

For a given block error rate (BLER), a modulation level and coding scheme (MCS) is determined by a UE based on the observed signal to noise and interference ratio (SINR), which is reported by a channel quality indicator (CQI). NR supports transmission of either one or two transport blocks (TBs) to a UE in a slot, depending on the rank. One TB is used for ranks 1 to 4, and two TBs are used for ranks 5 to 8. A CQI is associated to each TB. The CQI/RI/PMI report can be either wideband or subband based on configuration. RI, PMI, and CQI are part of CSI and reported by a UE to a network node or gNB.

### Channel State Information Reference Signal (CSI-RS) and CSI-IM

A CSI-RS is transmitted on each transmit antenna port and is used by a UE to measure downlink channel associated with each of the antenna ports. The antenna ports are also referred to as CSI-RS ports. The supported number of antenna ports in NR are {1,2,4,8,12,16,24,32}. By measuring the received CSI-RS, a UE can estimate the channel the CSI-RS is traversing, including the radio propagation channel and antenna gains. CSI-RS for this purpose is also referred to as Non-Zero Power (NZP) CSI-RS.

NZP CSI-RS can be configured to be transmitted in certain REs per physical resource block (PRB). FIG. 3 shows an example of a NZP CSI-RS resource configuration with 4 CSI-RS ports in a PRB in one slot.

In addition to NZP CSI-RS, Zero Power (ZP) CSI-RS was defined in NR to indicate to a UE the associated REs that are not available for PDSCH scheduling at the gNB. ZP CSI-RS can have the same RE patterns as NZP CSI-RS.

CSI resource for interference measurement, CSI-IM, is also defined in NR for a UE to measure noise and interference, e.g. from other cells. CSI-IM comprises of 4 REs in a slot. Two different CSI-IM patterns are defined: the CSI-IM pattern can be either 4 consecutive REs in one OFDM symbol or two consecutive REs in both frequency and time domains. An example of CSI-IM (option 1) and CSI-IM (option 2) is shown in FIG. 4. Typically, the gNB does not transmit any signal in the CSI-IM resource so that what is observed in the resource is noise and interference from other cells.

### CSI Framework in NR

In NR, a UE can be configured with one or multiple CSI report configurations. Each CSI report configuration (defined by a higher layer information element (IE) CSI-ReportConfig) is associated with a BWP and contains one or more of:
a CSI resource configuration for channel measurement;
a CSI-IM resource configuration for interference measurement;
a NZP CSI-RS resource for interference measurement;
reporting type, i.e., aperiodic CSI (on PUSCH), periodic CSI (on PUCCH) or semi-persistent CSI (on PUCCH, and DCI activated on PUSCH);
report quantity specifying what to be reported, such as RI, PMI, CQI;
codebook configuration such as type I or type II CSI;
frequency domain configuration, i.e., subband vs. wideband CQI or PMI, and subband size.

The CSI-ReportConfig IE is illustrated in the RRC specification (e.g. 3GPP TS 38.331).

A UE can be configured with one or multiple CSI resource configurations each with a CSI-ResourceConfigId, for channel and interference measurement. Each CSI resource configuration for channel measurement or for NZP CSI-RS based interference measurement can contain one or more NZP CSI-RS resource sets. For each NZP CSI-RS resource set, it can further contain one or more NZP CSI-RS resources. A NZP CSI-RS resource can be periodic, semi-persistent, or aperiodic.

Similarly, each CSI-IM resource configuration for interference measurement can contain one or more CSI-IM resource sets. For each CSI-IM resource set, it can further contain one or more CSI-IM resources. A CSI-IM resource can be periodic, semi-persistent, or aperiodic.

Periodic CSI starts after it has been configured by Radio Resource Control (RRC) and is reported on PUCCH, the associated NZP CSI-RS resource(s) and CSI-IM resource(s) are also periodic.

For semi-persistent CSI, it can be either on PUCCH or PUSCH. Semi-persistent CSI on PUCCH is activated or deactivated by a Medium Access Control (MAC) Control Element (CE) command. Semi-persistent CSI on PUSCH is activated or deactivated by DCI. The associated NZP CSI-RS resource(s) and CSI-IM resource(s) can be either periodic or semi-persistent.

For aperiodic CSI, it is reported on PUSCH and is activated by a CSI request bit field in DCI. The associated NZP CSI-RS resource(s) and CSI-IM resource(s) can be either periodic, semi-persistent, or aperiodic. The linkage between a codepoint of the CSI request field and a CSI report configuration is via an aperiodic CSI trigger state. A UE is configured by higher layer with a list of aperiodic CSI trigger states, where each of the trigger states contains an associated CSI report configuration. The CSI request field is used to indicate one of the aperiodic CSI trigger states and thus, one CSI report configuration.

If there are more than one NZP CSI-RS resource set and/or more than one CSI-IM resource set associated with a CSI report configuration, only one NZP CSI-RS resource set and one CSI-IM resource set are selected in the aperiodic CSI trigger state. Thus, each aperiodic CSI report is based on a single NZP CSI-RS resource set and a single CSI-IM resource set.

In case multiple NZP CSI-RS resources are configured in a NZP CSI-RS resource set for channel measurement, the UE would select one NZP CSI-RS resource and report a CSI associated with the selected NZP CSI-RS resource. A CRI (CSI-RS resource indicator) would be reported as part of the CSI. In this case, the same number of CSI-IM resources, each paired with a NZP CSI-RS resource need to be configured in the associated CSI-IM resource set. That is, when a UE reports a CRI value k, this corresponds to the (k+1)^{th} entry of the NZP CSI-RS resource set for channel measurement, and, if configured, the (k+1)^{th} entry of the CSI-IM resource set for interference measurement (see for example, clause 5.2.1.4.2 of 3GPP TS 38.214).

When NZP CSI-RS resource(s) are configured for interference measurement in a CSI-ReportConfig, only a single NZP-CSI-RS resource in a CSI-RS resource set can be configured for channel measurement in the same CSI-ReportConfig.

### Non-Coherent Joint Transmission (NC-JT)

In NR Rel-15, only PDSCH transmission from a single TRP is supported, in which a UE receives PDSCH from a single TRP at any given time.

In NR Rel-16, PDSCH transmission over multiple TRPs was introduced. One of the multi-TRP schemes is NC-JT, in which a PDSCH to a UE in transmitted over two TRPs with different MIMO layers of the PDSCH transmitted from different TRPs. For example, 2 layers can be transmitted from a first TRP and 1 layer can be transmitted from a second TRP.

NC-JT refers to MIMO data transmission over multiple TRPs in which different MIMO layers are sent over different TRPs. An example is shown in FIG. 4, where a PDSCH is sent to a UE over two TRPs, each carrying one code word (CW). When the UE has 4 receive antennas while each of the TRPs has only 2 transmit antennas, the UE can support up to 4 MIMO layers but there is a maximum of 2 MIMO layers from each TRP. In this case, by transmitting data over two TRPs to the UE, the peak data rate to the UE can be increased as up to 4 aggregated layers from the two TRPs can be used. This is beneficial when the traffic load and thus the resource utilization, is low in each TRP. The scheme can also be beneficial in the case where the UE is in line of sight (LOS) of both the TRPs and the rank per TRP is limited even when there are more transmit antennas available at each TRP.

This type of NC-JT is supported in LTE with two TRPs, each up to 8 antenna ports. For CSI feedback purpose, a UE is configured with a CSI process with two NZP CSI-RS resources, one for each TRP, and one interference measurement resource. The UE may report one of the following scenarios:
1. A UE reports CRI=0, which indicates that CSI is calculated and reported only for the first NZP CSI-RS resource, i.e., a RI, a PMI and a CQI associated with the first NZP CSI-RS resource is reported. This is the case when the UE sees that the best throughput is achieved by transmitting a PDSCH over the TRP or beam associated with the first NZP CSI-RS resource.
2. A UE reports CRI=1, which indicates that only CSI is calculated and reported for the second NZP CSI-RS resource, i.e., a RI, a PMI and a CQI associated with the second NZP CSI-RS resource is reported. This is the case when the UE sees that the best throughput is achieved by transmitting a PDSCH over the TRP or beam associated with the second NZP CSI-RS resource.
3. A UE reports CRI=2, which indicates both of the two NZP CSI-RS resources are reported. In this case, two set of CSIs, each for one CW, are calculated and reported based on the two NZP CSI-RS resources and by considering inter-CW interference caused by the other CW. The combinations of reported RIs are restricted such that |RI1−RI2|<=1, where RI1 and RI2 respectively correspond to ranks associated with the 1^{st} and the 2^{nd} NZP CSI-RS.

In NR Rel-16, a different approach is adopted where a single CW is transmitted across two TRPs. An example is shown in FIG. 5, where one layer is transmitted from each of two TRPs.

Two flavors of NC-JT are supported, i.e., single DCI based N-JT and multi-DCI based NC-JT. In single DCI based NC-JT, it is assumed that a single scheduler is used to schedule data transmission over multiple TRPs, different layers of a single PDSCH scheduled by a single PDCCH can be transmitted from different TRPs.

In multi-DCI based NC-JT, independent schedulers are assumed in different TRPs to schedule PDSCHs to a UE. Two PDSCHs scheduled from two TRPs may be fully or partially overlapped in time and frequency resource. Only semi-static coordination between TRPs may be possible.

### NC-JT CSI in NR Rel-17

It has been agreed that, for CSI measurement associated to a reporting setting (represented by higher layer parameter CSI-ReportConfig) for NC-JT, there will be:
Ks≥2 NZP CSI-RS resources in a CSI-RS resource set for channel measurement; the Ks resources will be referred to as channel measurement resources (CMR), and
Within the Ks CMRs, N≥1 NZP CSI-RS resource pairs are for NC-JT CSI, whereas each pair is used for a NC-JT CSI measurement hypothesis.

In addition, the Ks≥2 NZP CSI-RS resources can be divided into two different CMR groups, and that each of the N pairs used for NC-JT CSI measurement hypothesis could be associated with one CMR from each of the two CMR groups.

On Quasi-Colocation (QCL) relation between CMR and CSI-IM in a measurement hypothesis, it has been agreed that the UE should assume the same QCL-Type D for a CSI-IM associated with a NC-JT measurement hypothesis as the CMRs associated with the same NC-JT measurement hypothesis. This means, for example, if CMR1 is QCL-Type D with a first DL-RS (DL-RS 1), CMR2 is QCL-Type D with a second DL-RS (DL-RS 2), and CMR1 and CMR 2 are associated with a NC-JT measurement hypothesis, then an CSI-IM associated with the same NC-JT hypothesis should be measured with the assumption that it is QCL-Type D with both DL-RS 1 and DL-RS 2.

### SUMMARY

There currently exist certain challenge(s). For example, higher-layer signaling can be used to configure the N CMR pairs. How this signaling is performed is for further study. Also, whether using higher layer signaling to dynamically indicate CMR pairs for NCJT measurement hypothesis and/or dynamically indicating CMRs for single TRP (sTRP) measurement hypothesis is still to be determined. In addition, whether a CMR used for sTRP measurement hypothesis can be also re-used for a NC-JT measurement hypothesis for both frequency range 1 (FR1) and FR2, or only for FR1 is to be determined.

Also, on CSI-IM configuration, whether a CSI-IM (i.e. IMR) can be re-used for both NC-JT and sTRP measurement hypothesis, or if different CSI-IM are needed for different measurement hypothesis is an issue. Two alternatives, i.e. Alt.1 and Alt.2, have been proposed.

In Alt.1, the same CSI-IM can be re-used both for a sTRP and a NC-JT measurement hypothesis. So for example, assume that two CMRs (CMR1 & CMR2) and two IMRs (IMR1 & IMR2) are configured in a CSI report setting for NC-JT CSI reporting, then the UE can utilize IMR1 for sTRP measurement hypothesis on CMR1, IMR2 for sTRP measurement hypothesis for CMR2, and both IMR1 and IMR2 for NC-JT measurement hypothesis for CMR1 and CMR2 (for example taking the average interference measured on both IMR1 and IMR2).

In Alt.2, it is assumed that different IMRs are used for different measurement hypotheses, so for example if we have configured two CMRs (CMR1 and CMR2), and aim to use them for two sTRP measurement hypotheses, and one NC-JT measurement hypothesis, then we need to configure 3 IMRs, one for each sTRP measurement hypothesis and one for the NC-JT measurement hypothesis.

In case higher layer signaling is used to dynamically indicate which CMRs to be used for which NC-JT or sTRP measurement hypotheses, how to map CSI-IM (i.e. IMR) to NC-JT and/or sTRP measurement hypotheses is an issue.

In addition, methods on how to use RRC signaling to indicate CMRs for NC-JT and/or sTRP measurement hypothesis (including “activating”/“de-activating” sTRP and NC-JT measurement hypotheses) were disclosed in a prior document as well as how to use MAC-CE to indicate CMRs for NC-JT measurement hypothesis (including “activating”/“de-activating” NCJT measurement hypotheses). However, how to update the CMRs for sTRP measurement hypothesis is still an open issue.

Furthermore, how to handle the updates of CMRs and IMRs such that RS overhead and UE computation efforts are reduced is another open issue.

Certain aspects of the disclosure and their embodiments may provide solutions to these or other challenges.

For example, a framework for associating CSI-IM with NC-JT/sTRP measurement hypotheses is proposed.

Signaling for dynamically indicating CMRs for sTRP measurement hypotheses using MAC-CE is also proposed.

Explicit or implicit activation/de-activation of CSI-IMs associated with NC-JT/sTRP measurement hypotheses is also proposed. For example, the disclosure allows to associate CSI-IMs with NC-JT/sTRP measurement hypotheses and also provides MAC-CE signaling details on which CMR resources the UE can use for NC-JT CSI hypothesis and which CMR resources the UE can use for single-TRP hypothesis.

According to one aspect, there is provided a method performed by a UE for performing a plurality of CSI measurements for CSI reporting, wherein at least a first of the plurality of CSI measurements is based on a single CSI-RS resource and at least a second of the plurality of CSI measurements is based on a pair of CSI-RS resources, the UE being configured with a set of CMRs and a set of IMRs. The method may comprise: obtaining a configuration including an indication of: a first number (M) of resources in the set of CMRs for performing the first of the plurality of CSI measurements, a second number (N) of resource pairs from the set of CMRs for performing the second of the plurality of CSI measurements, a third number of resources in the set of IMRs, and an association between the resources in the set of CMRs and the resources in the set of IMRs, wherein the association comprises associating the M resources in the set of CMRs with M resources in the set of IMRs based on a first ordering of the M resources in the set of CMRs and in the set of IMRs and associating the N resource pairs with N resources in the set of IMRs based on a second ordering of the N resource pairs in the set of CMRs and the N resources in the set of IMRs; and performing CSI measurements based at least on the obtained configuration.

A second method can be provided for the UE for performing a plurality of CSI measurements. The method may comprise: obtaining a configuration including an indication of: a first group of CMRs within the set of CMRs with a first number (M₁) of resources and a second group of CMRs within the set of CMRs with a second number (M₂) of resources for performing the first of the plurality of CSI measurements, a third number (N) of resource pairs from the set of CMRs for performing the second of the plurality of CSI measurements, a fourth number of resources in the set of IMRs, and an association between the resources in the first group and second group of CMRs in the set of CMRs and the resources in the set of IMRs, wherein the association comprises associating the M₁ and M₂ resources in the set of CMRs with respective M₁ and M₂ resources in the set of IMRs and associating the N resource pairs with N resources in the set of IMRs; and performing CSI measurements based at least on to the obtained configuration.

According to another aspect, a UE comprising network interfaces and processing circuitry can be configured to perform any one of the above 2 methods.

According to another aspect, there is provided a method in a network node, for receiving a CSI report, from a UE, the CSI report comprising a plurality of CSI measurements, wherein at least a first of the plurality of CSI measurements is based on a single CSI-RS resource and at least a second of the plurality of CSI measurements is based on a pair of CSI-RS resources. The method may comprise: transmitting a configuration including an indication of: a first number (M) of resources in a set of CMRs for performing the first of the plurality of CSI measurements, a second number (N) of resource pairs from the set of CMRs for performing the second of the plurality of CSI measurements, a third number of resources in a set of IMRs, and an association between the resources in the set of CMRs and the resources in the set of IMRs, wherein the association comprises associating the M resources in the set of CMRs with M resources in the set of IMRs based on a first ordering of the M resources in the set of CMRs and in the set of IMRs and associating the N resource pairs with N resources in the set of IMRs based on a second ordering of the N resource pairs in the set of CMRs and the N resources in the set of IMRs; and receiving from the UE a CSI report comprising CSI measurements based at least on the transmitted configuration.

In another example, a method at the network node can comprise: transmitting a configuration including an indication of: a first group of CMRs within a set of CMRs with a first number (M₁) of resources and a second group of CMRs within the set of CMRs with a second number (M₂) of resources for performing the first of the plurality of CSI measurements, a third number (N) of resource pairs from the set of CMRs for performing the second of the plurality of CSI measurements, a fourth number of resources in a set of IMRs, and an association between the resources in the first group and second group of CMRs in the set of CMRs and the resources in the set of IMRs, wherein the association comprises associating the M₁ and M₂ resources in the set of CMRs with M₁ and M₂ resources in the set of IMRs and associating the N resource pairs with N resources in the set of IMRs; and receiving a CSI report from the UE, the CSI report comprising CSI measurements based at least on to the transmitted configuration.

According to another aspect, a network node comprising network interfaces and processing circuitry can be configured to perform any one of the above 2 methods.

Certain embodiments may provide one or more of the following technical advantage(s).

For example, associating CSI-IM to NC-JT/sTRP measurement hypothesis enables the NC-JT framework to work properly, since the UE will know which IMRs to use for which measurement hypotheses, which will generate more reliable CSI calculations.

By dynamically changing the sTRP measurement hypothesis for a UE with MAC-CE, the network can in a flexible way adapt which TRPs (or CMRs) the UE should calculate sTRP CSI for, and in that way improve the flexibility and performance in the system.

Implicitly/explicitly de-activating/activating CSI-IM based on the indicated sTRP/NC-JT measurement hypotheses will optimize the CSI-RS overhead/and UE computation efforts.

### BRIEF DESCRIPTION OF THE DRAWINGS

Exemplary embodiments will be described in more detail with reference to the following figures, in which:

FIG. 1 illustrates a NR time-domain structure with 15 KHz subcarrier spacing.

FIG. 2 illustrates a NR physical resource grid.

FIG. 3 illustrates an example of RE allocation for a 4-port CSI-RS in NR.

FIG. 4 illustrates an example of NC-JT supported in LTE, where a CW is transmitted from one TRP.

FIG. 5 illustrates an example of NC-JT supported in NR Rel-16 where a single CW is transmitted over two TRPs.

FIG. 6 illustrates an example of an association between IMRs, CMRs and measurement hypotheses (sTRP and NCJT), according to an embodiment.

FIG. 7 illustrates an example of another embodiment in configuring CMR groups and CSI hypotheses.

FIG. 8 illustrates an example of a MAC CE for indicating NC-JT hypothesis.

FIG. 9 illustrates an example of a MAC CE for indicating CMR pairs and CMRs for NC-JT measurement hypotheses and sTRP measurement hypotheses.

FIG. 10 illustrates an example of MAC CE, which comprises first fields (Si) corresponding to NC-JT measurement hypotheses and second fields (Ti) corresponding to sTRP measurement hypotheses, according to some embodiment.

FIG. 11 illustrates an example of a MAC CE, without Ti fields, according to one embodiment.

FIG. 12 illustrates an example of MAC CE using hypothesis indexes, according to some embodiments.

FIG. 13 illustrates an example of MAC CE using hypothesis indexes for a plurality of CSI reports, according to some embodiments.

FIG. 14 illustrates a flow chart of a method in a UE, according to an embodiment.

FIG. 15 illustrates a flow chart of another method in a UE, according to an embodiment.

FIG. 16 illustrates a flow chart of a method in a network node, according to an embodiment.

FIG. 17 illustrates a flow chart of another method in a network node, according to an embodiment.

FIG. 18 shows an example of a communication system, according to an embodiment.

FIG. 19 shows a schematic diagram of a UE, according to an embodiment.

FIG. 20 shows a schematic diagram of a network node, according to an embodiment.

FIG. 21 illustrates a block diagram of a host.

FIG. 22 illustrates a block diagram illustrating a virtualization environment.

FIG. 23 shows a communication diagram of a host.

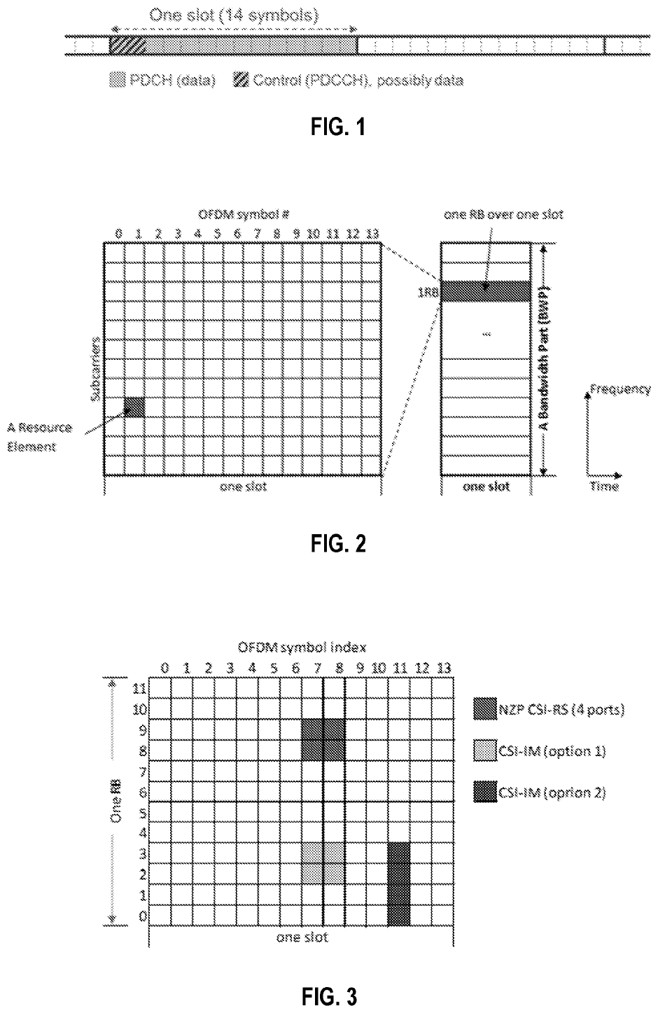

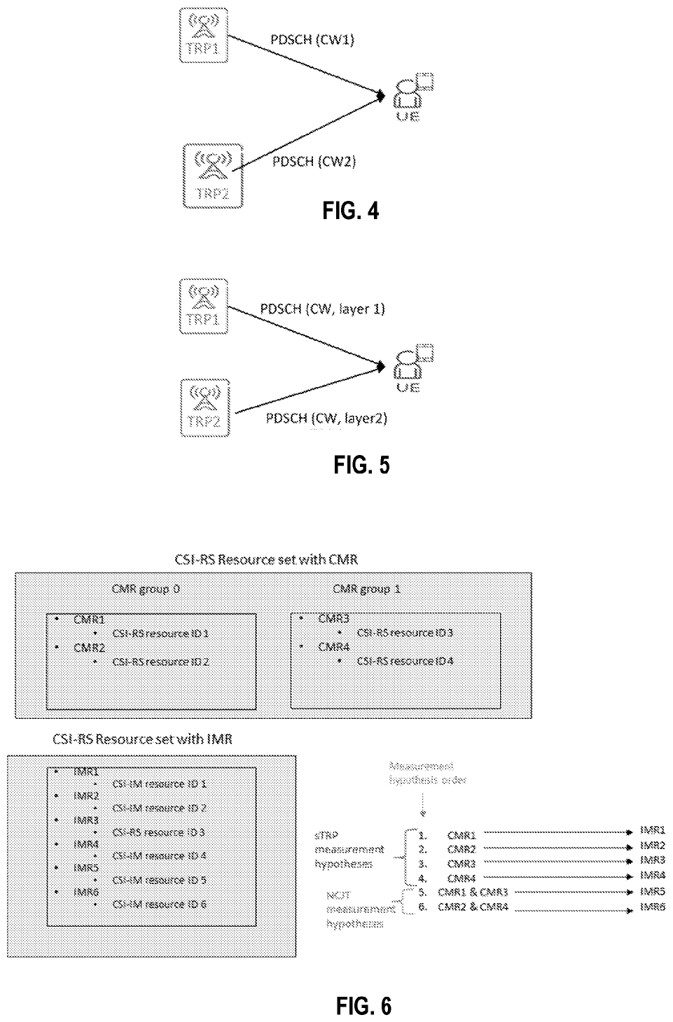

### DETAILED DESCRIPTION

Some of the embodiments contemplated herein will now be described more fully with reference to the accompanying drawings. Embodiments are provided by way of example to convey the scope of the subject matter to those skilled in the art.

It should be noted that even though the terms sTRP CSI measurement hypothesis (or sTRP measurement hypothesis) and NC-JT CSI measurement hypothesis (or NC-JT measurement hypothesis) are used in this disclosure, these terms may not necessarily be captured in 3GPP specifications.

For example, a sTRP CSI measurement hypothesis may be represented by a CSI measurement for a CSI calculated based on channel measurements performed on a single NZP CSI-RS resource. The TRP for which the sTRP CSI measurement hypothesis corresponds to transmits a NZP CSI-RS in this NZP CSI-RS resource. In addition, interference measurement to be used in this CSI calculation may also be performed on an interference measurement resource (IMR). The CSI calculated based on the sTRP CSI measurement hypothesis is referred to as a sTRP CSI which comprises one or more of an RI, PMI, and CQI (wideband and/or subband CQI). In some examples, the sTRP CSI may also comprise a CRI, where the CRI indicates a NZP CSI-RS resource among a set or group of NZP CSI-RS resources which is used as the CMR for calculating the sTRP CSI.

In some examples, a NC-JT CSI measurement hypothesis may be represented by a CSI measurement for a CSI calculated based on channel measurements performed on a pair of NZP CSI-RS resources. The two TRPs for which the NC-JT CSI measurement hypothesis corresponds to each transmits a NZP CSI-RS in the respective NZP CSI-RS resources. The pair of NZP CSI-RS resources used for channel measurement may be from different channel measurement resource groups. The CSI calculated based on NC-JT CSI measurement hypothesis is referred to as a NC-JT CSI which comprises a pair of RIs, a pair of PMIs, and joint CQI (wideband and/or subband CQI). For example, the NC-JT CSI may also comprise a pair of CRIs. The CRIs may indicate a pair of NZP CSI-RS resources belonging to two different channel measurement groups or NZP CSI-RS resource groups. The pair of CRIs may be signaled to the UE from the gNB (via RRC and/or MAC CE).

Embodiments related to associating CSI-IMs with NC-JT/sTRP measurement hypotheses

### Embodiment 1A

In this embodiment, it is assumed that one CSI-IM is associated with a sTRP or NC-JT measurement hypothesis. One example of this is illustrated in Error! Reference source not found. 6, where 4 CMRs (two per CMR group, i.e. CMR group 0 and CMR group 1) are configured in the CSI-RS resource set used for CSI measurement, and where the gNB has indicated 4 sTRP measurement hypotheses and two NC-JT measurement hypotheses. For example, FIG. 6 shows an order of measurement hypothesis from 1 to 6, where the first 4 measurement hypotheses are sTRP measurement hypotheses and are associated with CMR1 to CMR 4 respectively. The last 2 measurement hypotheses are NC-JT measurements and are associated with 2 resource pairs each (e.g. CM1 & CMR3, and, CM2& CMR4). Since the total number of measurement hypotheses is equal to 6 (4 sTRP measurement hypotheses +2 NC-JT measurement hypotheses), the UE is configured with 6 CSI-IMs in the CSI-RS resource set for IMR.

In this embodiment, there is an implicit mapping between a measurement hypothesis and a CSI-IM (e.g. IMR) based on a certain order of the measurement hypotheses (referred to as “Measurement hypothesis order” in FIG. 6) and a certain order of the CSI-IMs, such that the first measurement hypothesis is associated with the first CSI-IM, the second measurement hypothesis is associated with a second CSI-IM and so on. For example, as shown in FIG. 6, the first sTRP measurement hypothesis, which is mapped/associated to CMR1, is associated/mapped to the first IMR1 and so on. The CMRs and CSI-IMs here are associated with the same CSI report configuration, for example.

In more details, as shown in FIG. 6, the measurement hypotheses can be ordered according to:
Start with sTRP measurement hypotheses:
   a. Of all sTRP measurement hypotheses, start with sTRP measurement hypothesis that is associated with CMRs belonging to CMR group 0:
      i. Of all sTRP measurement hypotheses that is associated with CMRs belonging to CMR group 0, order them according to lowest CSI-RS resource ID (i.e. lowest NZP-CSI-RS-ResourceId as specified in 3GPP TS 38.331), such that the CMR with lowest CSI-RS resource ID is first in order, the CSI-RS resource with second lowest CSI-RS resource ID is second in order, and so on. Alternatively, the CMRs can be ordered according to their order in the corresponding NZP CSI-RS resource set.
   b. Continue with all sTRP measurement hypotheses with CMRs associated with CMR group 1:
      i. Of all sTRP measurement hypotheses that is associated with CMRs belonging to CMR group 1, order them according to lowest CSI-RS resource ID, such that the CMR with lowest CSI-RS resource ID is first in order, the CSI-RS resource with second lowest CSI-RS resource ID is second in order, and so on. Alternatively, the CMRs can be ordered according to their order in the corresponding NZP CSI-RS resource set.
   c. Continue with all NC-JT measurement hypotheses:
      i. Order them according to the NC-JT measurement hypothesis that is associated with a CMR with lowest CSI-RS resource ID (so for example, if one NC-JT measurement hypothesis is associated with a CMR pair consisting of CSI-RS resources with CSI-RS resource ID 1 and CSI-RS resource ID 2, and a second NC-JT measurement hypothesis is associated with a CMR pair consisting of CSI-RS resources with CSI-RS resource ID 2 and CSI-RS resource ID 3, then the former NC-JT measurement hypothesis should be ordered first, since it is associated with a CMR with lowest CSI-RS resource ID). Alternatively, the NC-JT hypotheses can be ordered according to the order of the associated CMRs in the corresponding NZP CSI-RS resource set.
      ii. In case two NC-JT measurement hypotheses share a CMR which has the lowest CSI-RS resource ID for both these NC-JT measurement hypotheses, then the two NC-JT measurement hypotheses can be ordered based on the lowest CSI-RS resource ID for the second CMR associated for respective NC-JT measurement hypothesis (so for example, if one NC-JT measurement hypothesis is associated with a CMR pair consisting of CSI-RS resources with CSI-RS resource ID 1 and CSI-RS resource ID 4, and a second NC-JT measurement hypothesis is associated with a CMR pair consisting of CSI-RS resources with CSI-RS resource ID 1 and CSI-RS resource ID 6, then the former NC-JT measurement hypothesis should be ordered first since the CSI-RS resource ID for the “non-shared CMR” is lower. Alternatively, the two NC-JT measurement hypotheses can be ordered according to the order of the second CMRs in the corresponding NZP CSI-RS resource set.

Note that other orders of the measurement hypotheses are possible. For example, the NC-JT measurement hypotheses can be ordered before the sTRP measurement hypotheses.

In one example (as is also used in the example in FIG. 6), the CSI-IM in the CSI-IM resource set for IMR is based on the lowest CSI-IM resource ID (i.e. lowest CSI-IM-ResourceId as specified in 3GPP TS 38.331). Alternatively, the IMRs can be ordered according to their order in the corresponding CSI-IM resource set.

In case the gNB uses MAC-CE to indicate/update a new set of sTRP and/or NC-JT measurement hypotheses, the UE can re-calculate the measurement hypothesis order, and based on the new measurement hypothesis order, associate the CSI-IMs with the new set of measurement hypotheses.

In case there are less “activated” measurement hypotheses than there are CSI-IMs configured in the CSI-RS resource set for IMR, the UE can assume that the redundant CSI-IMs are “de-activated” (i.e. the UE does not need to perform measurement on these CSI-IMs anymore). For example, assume that the gNB in FIG. 6 de-activates the two NC-JT measurement hypotheses. In this case, there will only be 4 (sTRP) measurement hypotheses left, while there are 6 CSI-IMs in the CSI-RS resource set for IMR. In this case, the two CSI-IMs last in the order (i.e. with highest CSI-IM resource ID) will be “de-activated”, and the UE can ignore them.

In an example of a NC-JT CSI report, it is not allowed to activate more measurement hypotheses than the number of CSI-IMs in the corresponding CSI-RS resource set with IMRs.

### Embodiment 1B

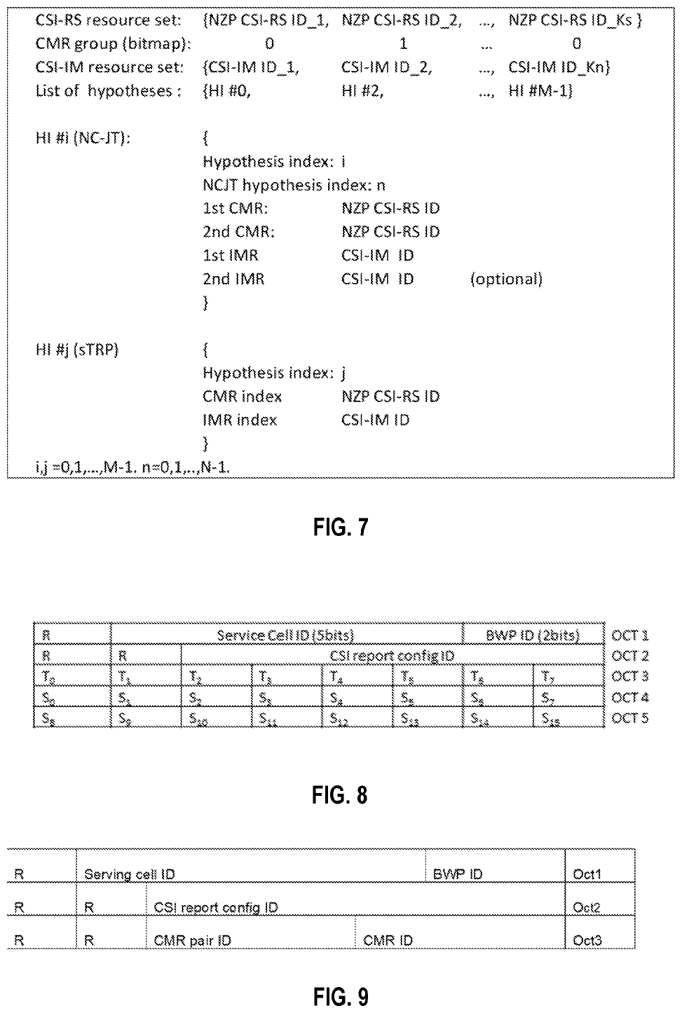

In this embodiment, the CSI measurement hypotheses are explicitly configured as shown in FIG. 7, involving a CSI resource set with Ks NZP CSI-RS resources as CMRs and a CSI-IM resource set with Kn CSI-IM resources. A bit map (or an index) can be used to associate each NZP CSI-RS resource to a CMR group. A list of M>0 CSI hypotheses (either sTRP or NC-JT), each with a hypothesis index, are configured. Each hypothesis comprises a hypothesis index, one or two CMRs, and one or two IMRs. If two CMRs are included, they belong to different CMR groups, and the hypothesis is for NC-JT CSI measurements. For each NC-JT CSI measurements hypothesis, a local NC-JT hypothesis index, n, may also be included, which is used to count only NC-JT measurement hypotheses. The maximum number of NC-JT hypotheses may also be configurable. If one CMR is included in a hypothesis, the hypothesis is for sTRP CSI measurements. The CMRs in the hypotheses are a subset of NZP CSI-RS resources in the NZP CSI-RS resource set, and the IMRs are a subset of CSI-IM resources in the CSI-IM resource set. The sTRP and NC-JT hypotheses can be in any order.

### Embodiments Related to Using MAC-CE to Dynamically Indicate sTRP Measurement Hypotheses

### Embodiment 2A

In this embodiment, a MAC-CE is used to dynamically indicate which NC-JT and/or sTRP measurement hypotheses the UE should activate for CSI reporting associated with a CSI Report configuration (i.e. CSI-ReportConfig as defined in 3GPP TS 38.214 V16.5.0). One example, if we assume that the maximum number of NZP CSI-RS resources in a CSI-RS resource set used for NC-JT CSI is equal to 8, then the maximum number of candidate NC-JT CSI measurement hypotheses would be k1*k2=4*4=16, where k1 is the number of NZP CSI-RS resources in CMR group 0 and k2 is the number of NZP CSI-RS resources in CMR group 1, and the maximum number of candidate sTRP measurement hypotheses is k1+k2=4+4=8.

Note that if all NC-JT and sTRP CSI measurement hypotheses are known, the measurement hypotheses can be fixed in the specification and no RRC configuration is needed. However, computing CSI for all NC-JT and sTRP measurement hypotheses will be a huge burden for the UE. A more practical solution is to RRC configure only a finite number of CMR pairs for a finite number of NC-JT and sTRP measurement hypotheses and have MAC CEs further down select one or a subset of the configured NC-JT and sTRP measurement hypotheses.

Let us take an example where a CSI report configuration is configured with a NZP CSI-RS resource set for channel measurement with 5 NZP CSI-RS resources (i.e., 5 CMRs). Further assume that the CMRs are divided into two CMR groups, with three CMRs in CMR group 0 and 2 CMRs in CMR group 1. Since each NC-JT measurement hypothesis should consist of one CMR from each CMR group, there are 6 possible NC-JT measurement hypotheses for this NZP CSI-RS resource set. The corresponding CMR pairs for these 6 possible NC-JT measurement hypotheses are CMR1-CMR4, CMR1-CMR5, CMR2-CMR4, CMR2-CMR5, CMR3-CMR4, and CMR3-CMR5. In addition, there are 5 possible sTRP measurement hypotheses, one per CMR.

The MAC CE has two fields that are bit strings, where each bit of the first field indicates one (or more) of the possible NC-JT measurement hypotheses, and each bit of the second field indicates one or more of the possible sTRP measurement hypotheses. Note that the benefit with this approach is that the number of NC-JT and sTRP CSI measurement hypotheses can by updated dynamically from the gNB to the UE using the MAC CE.

Each bit in the first field indicates one of the CMR pairs corresponding to one of the possible NC-JT measurement hypotheses. Then, the first field in the MAC CE may consist of 6 bits [S₀ S₁ S₂ S₃ S₄ S₅] where the mapping of the bits to the CMR pairs may for example be given as follows: bit S₀ corresponds to CMR pair CMR1-CMR4; bit S₁ corresponds to CMR pair CMR1-CMR5; bit S₂ corresponds to CMR pair CMR2-CMR4; bit S₃ corresponds to CMR pair CMR2-CMR5; bit S₄ corresponds to CMR pair CMR3-CMR4; and bit S₅ corresponds to CMR pair CMR3-CMR5.

In a similar way, for the second bitfield, each bit indicates one of the CMRs corresponding to one of the possible sTRP measurement hypotheses. Then, the second field in the MAC CE may consist of 5 bits [T₀ T₁ T₂ T₃ T₄] where the mapping of the bits to the CMRs may for example be given as follows: bit T₀ corresponds to CMR1; bit T₁ corresponds to CMR2; bit T₂ corresponds to CMR3; bit T₃ corresponds to CMR4; and bit T₄ corresponds to CMR5.

In a given MAC CE, the UE may be indicated with one of the CMR pairs (e.g., one of the 6 bits in the first field set to 1 while the other 5 bits are set to 0). In this case, the UE measures the CMR pairs, computes CSI and reports NC-JT CSI corresponding to the indicated CMR pair. In the same MAC-CE, the UE may be indicated with one or more of the CMRs (e.g., one or more of the 5 bits in the second field set to 1 while the remaining bits are set to 0). In this case, the UE measures the CMRs, computes CSI and reports sTRP CSI corresponding to the indicated CMRs.

In an example, the UE may be indicated, via a MAC CE, with more than one CMR pair (e.g., two or more of the 6 bits of the first fieldset to 1). In this case, the UE measures the indicated multiple CMR pairs, computes CSI and only reports the NC-JT CSI corresponding to one of the CMR pairs. The NC-JT CSI to be reported may be determined by the UE as the NC-JT CSI that gives the best throughput (or using some other metric) among the NC-JT measurement hypotheses corresponding to the indicated multiple CMR pairs. In the same MAC-CE, the UE may be indicated with one or more of the CMRs for sTRP CSI measurement hypothesis (e.g., one or more of the 5 bits in the second field set to 1, while the remaining bits are set to 0). In this case, the UE measures the CMRs, computes CSI and reports sTRP CSI corresponding to the indicated CMRs. Note that the number of sTRP CSI measurement hypotheses can be varied dynamically via MAC CE by changing the number of CMRs corresponding to sTRP CSIs from one instance to another. For example, a first instance of the MAC CE may activate 3 sTRP CSI hypotheses, while a second instance of the MAC CE may activate 1 sTRP CSI hypothesis. The number of CSI measurement hypotheses can be varied based on network deployment needs. Similarly, the number of NC-JT CSI measurement hypotheses can be varied dynamically via MAC CE by changing the number of CMR pairs corresponding to NC-JT CSIs from one instance to another.

An example MAC CE that can indicate to the UE which NC-JT measurement hypotheses and sTRP measurement hypotheses to consider is given in FIG. 8. In this example, we assume a fixed list of 16 NC-JT measurement hypotheses and a fixed list of 8 sTRP measurement hypotheses. The fields in the MAC CE of FIG. 8 are as follows:

Serving Cell ID: This field indicates the identity of the Serving Cell for which the MAC CE applies.

BWP ID: This field indicates a UL BWP for which the MAC CE applies. Note that the BWP ID bitfield may be removed, since CSI anyway is configured per cell level.

CSI report config ID: This field indicates the ID of the CSI report configuration for which the NC-JT CSI measurement hypothesis (or hypotheses) are being indicated.

Sᵢ: This field indicates the selection status of the NC-JT measurement hypothesis (e.g., if possible NC-JT CSI measurement hypothesis List is specified in TS 38.331, then S₀ refers to the first NC-JT CSI measurement hypothesis within the list, S₁ refers to the second NC-JT CSI measurement hypothesis within the list, and so on). If Si is “1”, then the corresponding NC-JT CSI measurement hypothesis is activated. If Si is “0”, the corresponding NC-JT CSI measurement hypothesis is deactivated.

Tᵢ: This field indicates the selection status of the sTRP measurement hypothesis (e.g., To refers to the sTRP measurement hypothesis associated with a first CMR in the CSI-RS resource set used for NC-JT CSI, T₁ refers to the sTRP measurement hypothesis associated with a second CMR in the CSI-RS resource set used for NC-JT CSI, and so on). If Ti is “1”, then the corresponding sTRP CSI measurement hypothesis is activated. If Ti is “0”, the corresponding sTRP CSI measurement hypothesis is deactivated.

As an alternative in the above example, only a single “1” is indicated for both of the fields (i.e. only a single NC-JT measurement hypothesis and a single sTRP measurement hypothesis is indicated), then instead of bitmaps, the ID of the selection is explicitly given. This means that either by RRC or fixed in the specification, each CMR pair or CMR has an index. In the above example, the index for a CMR pair would be a 3 bits bitfield where the first 6 codepoints are used and the index for CMR would also be a 3 bit bitfield where the first 5 codepoints are used. These 2 three bits bitfields can be fitted to one octet and it is possible to express up to 8 CMR pairs and CMRs where each MAC CE would pick one each.

An example of such a MAC CE is shown in FIG. 9 and can have the following fields:
Serving cell ID: is the ID of the cell where the RSs are configured in.
BWP ID: is the BWP where the reference signals are configured in.
CMR pair ID: indicates the activated CMR pair
CMR ID: indicates the activated CMR

Only one bit corresponding to Ti can be set as 1.
R: is reserved field.

In one example, the NZP CSI-RS resource IDs may be directly signaled in the MAC CE. For instance, to indicate a NC-JT CSI measurement hypothesis, a CMR pair can be indicated in the MAC CE via two NZP CSI-RS resource IDs that represent the two CMRs in the CMR pair. Similarly, to indicate a sTRP CSI measurement hypothesis, a CMR can be indicated in the MAC CE via one NZP CSI-RS resource ID. To differentiate whether a NZP CSI-RS resource ID in the MAC CE belongs to a sTRP CSI measurement hypothesis or a NCJT CSI measurement hypothesis, a bit field (or flag bit) can be included for each NZP CSI-RS resource ID. If the flag bit indicates a first value, then the NZP CSI-RS resource ID is for the sTRP CSI measurement hypothesis. If the flag bit indicates a second value, then the NZP CSI-RS resource ID is for the NC-JT CSI measurement hypothesis. Two consecutive NZP CSI-RS resource IDs with their respective flag bits set to the second value are to be used for the same NC-JT CSI measurement hypothesis.

In one example, the NZP CSI-RS resource set ID where the CMRs to be used for NC-JT/sTRP CSI measurements are configured may be signaled instead of the CSI report config ID. Note that although 16 bits are shown in the Si field of the MAC CE of FIG. 8, the number of bits in the Si field may depend on the maximum number of candidate NC-JT measurement hypotheses. In a similar way, although 8 bits are shown for the Ti field, the number of bits in the Ti field may depend on the maximum number of candidate sTRP measurement hypotheses.

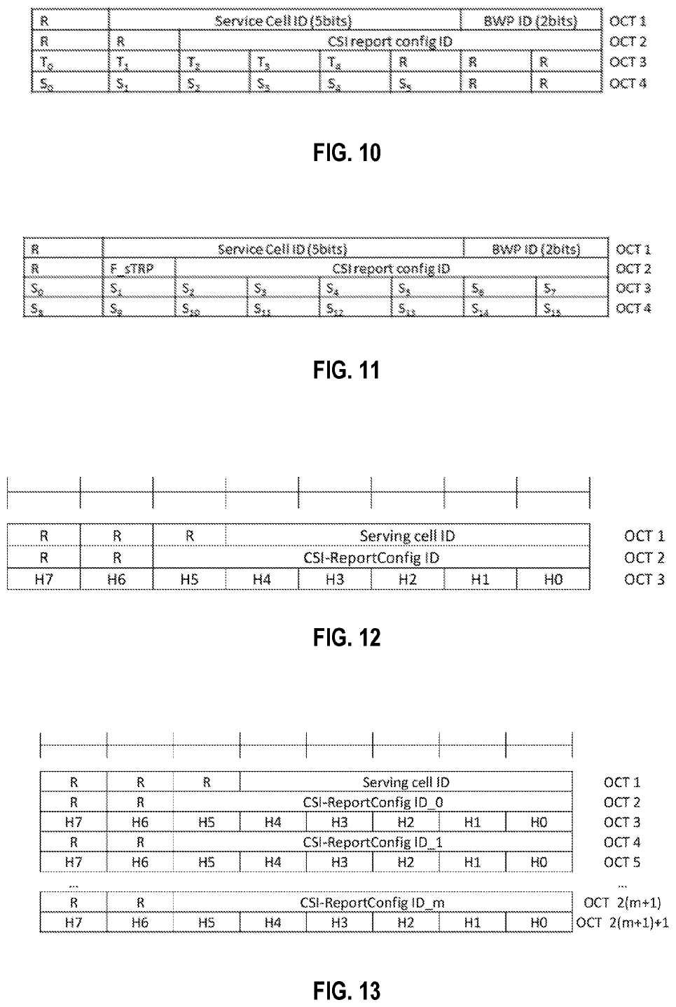

FIG. 10 shows another example MAC CE where the Si field has 6 bits which corresponds to 6 different NC-JT CSI measurement hypotheses and where the Ti field comprises bits corresponding to 5 different sTRP measurement hypotheses. The maximum number of NC-JT and/or sTRP measurement hypotheses may be predefined in 3GPP specifications.

Note that the MAC CE for indicating the CMRs for NC-JT/sTRP measurement hypotheses can be an independent MAC CE different from the MAC CE used for activating semi persistent CSI-RS resources which is given in clause 6.1.3.12 of 3GPP TS 38.321 V16.3.0.

One or more of the R fields of the MAC CEs of FIGS. 8 to 10 can be used to determine how the rest of the MAC CE is interpreted. For example, one R field can be turned into a C field and used to determine whether CSI-report config ID is included or NZP CSI-RS set ID is included. As another example, one R field can be turned into a F field and it determines whether the bitmaps Si and Ti are present or whether there is one octet with CMR pair ID and CMR ID fields.

In one example, the Si and Ti fields for indicating the sTRP/NCJT measurement hypotheses to the UE can be provided as part of the MAC CE for activating semi-persistent CSI-RS resources given in clause 6.1.3.12 of 3GPP TS 38.321 V16.3.0.

In one example, the Si and Ti fields for indicating the sTRP/NC-JT measurement hypotheses to the UE can be provided as part of the MAC CE for activating semi-persistent CSI reporting on PUCCH given in clause 6.1.3.16 of 3GPP TS 38.321 V16.3.0.

In one example, the Si and Ti fields for indicating the sTRP/NC-JT measurement hypotheses to the UE can be provided as part of the ‘Aperiodic CSI Trigger State Subselection MAC CE’ given in clause 6.1.3.13 of 3GPP TS 38.321 V16.3.0. In this example, the CMRs corresponding to the sTRP/NC-JT measurement hypotheses to be indicated are indicated per each selected aperiodic CSI trigger state.

In one example, the MAC CE can optionally be without the BWP ID.

In one example, instead of indicating the Si and Ti fields in the MAC CE, each CMR corresponding to the sTRP/NC-JT measurement hypotheses to be indicated to the UE is indicated via one or a pair of NZP CSI-RS resource ID(s) in the MAC CE.

In one example, the MAC-CE does not contain the Ti field. Instead a separate bitfield is used to indicate how the UE should calculate sTRP measurement hypotheses. One example of such MAC-CE is illustrated in FIG. 11, where a bit bitfield (F_sTRP) is included in the MAC-CE. This new bitfield can consist of one or more bits depending on how much flexibility that is needed.

In another example, the new bitfield can be used to indicate that the UE should calculate sTRP measurement hypotheses for all CMRs indicated for NC-JT measurement hypotheses (which is indicated by the Si field). For example, assume that the Si field indicates NC-JT measurement hypothesis for the CMR pair consisting of CMR1 and CMR3, then the new bitfield could be used to indicate to the UE that it should calculate sTRP measurement hypotheses for CMR1 and CMR3 (and not the other CMRs).

In one example, the new bitfield can be used to indicate that the UE should calculate sTRP measurement hypotheses for all CMRs in the NZP CSI-RS resource set used for NC-JT CSI. For example, assume that the Si field indicates NC-JT measurement hypothesis for the CMR pair consisting of CMR1 and CMR3 and that CMR2, CMR4 and CMR5 are not indicated for any NC-JT measurement hypotheses, then the new bitfield can indicate to the UE that it should calculate sTRP measurement hypotheses for all CMRs (CMR1, CMR2, CMR3, CMR4 and CMR5).

In one example, the new bitfield can be used to indicate that the UE should calculate sTRP measurement hypotheses for all CMRs not indicated for NC-JT measurement hypotheses (which is indicated by the Si field). For example, assume that the Si field indicates NC-JT measurement hypothesis for the CMR pair consisting of CMR1 and CMR3 (but nothing for the remaining CMR2, CMR4 & CMR5), then the new bitfield can indicate to the UE that it should calculate sTRP measurement hypotheses for the remaining CMRs (i.e. CMR2, CMR4 and CMR5). This could be useful for example if the UE should not/cannot re-use CMRs for sTRP and NC-JT measurement hypotheses. This means that the options of how the UE should calculate a certain hypothesis are linked to the codepoints of the new bitfield. This linking or mapping can be done as fixed in specification or it may be configured by RRC.

### Embodiment 2B

In one example, a hypothesis index as shown in FIG. 7 in a CSI report setting in a serving cell can be referred to in a MAC CE to activate/deactivate the corresponding hypothesis. Such an example of a MAC CE is shown in FIG. 12, where Hi (i=0, 1, . . . , 7) indicates a CSI hypothesis index to be activated (if Hi=1) or deactivated (if Hi=0).

Further, the MAC CE of FIG. 13 may contain multiple CSI-ReportConfig IDs to activate/deactivate CSI hypotheses in multiple CSI report settings.

In one example, whether both NC-JT CSI measurement hypotheses and sTRP CSI measurement hypotheses are being activated or only NC-JT CSI measurement hypotheses are being activated is indicated by a controller field in the MAC CE. If the field is set to one value, then fields that provide information regarding the CMRs for the sTRP CSI measurement hypothesis are absent from the MAC CE. If the field is set to a second value, then fields that provide information regarding the CMRs for the sTRP CSI measurement hypothesis to be activated are present in the MAC CE. So, the fields that provide information regarding the CMRs for the sTRP CSI measurement hypothesis are conditionally present in the MAC CE depending on the value indicated by the controller field.

In one example, whether both NC-JT CSI measurement hypotheses and sTRP CSI measurement hypotheses are being activated or only sTRP CSI measurement hypotheses are being activated is indicated by a controller field in the MAC CE. If the field is set to one value, then fields that provide information regarding the CMR pair(s) for the NC-JT CSI measurement hypothesis are absent from the MAC CE. If the field is set to a second value, then fields that provide information regarding the CMRs for the NC-JT CSI measurement hypothesis to be activated are present in the MAC CE. So, the fields that provide information regarding the CMRs for the NC-JT CSI measurement hypothesis are conditionally present in the MAC CE depending on the value indicated by the controller field.

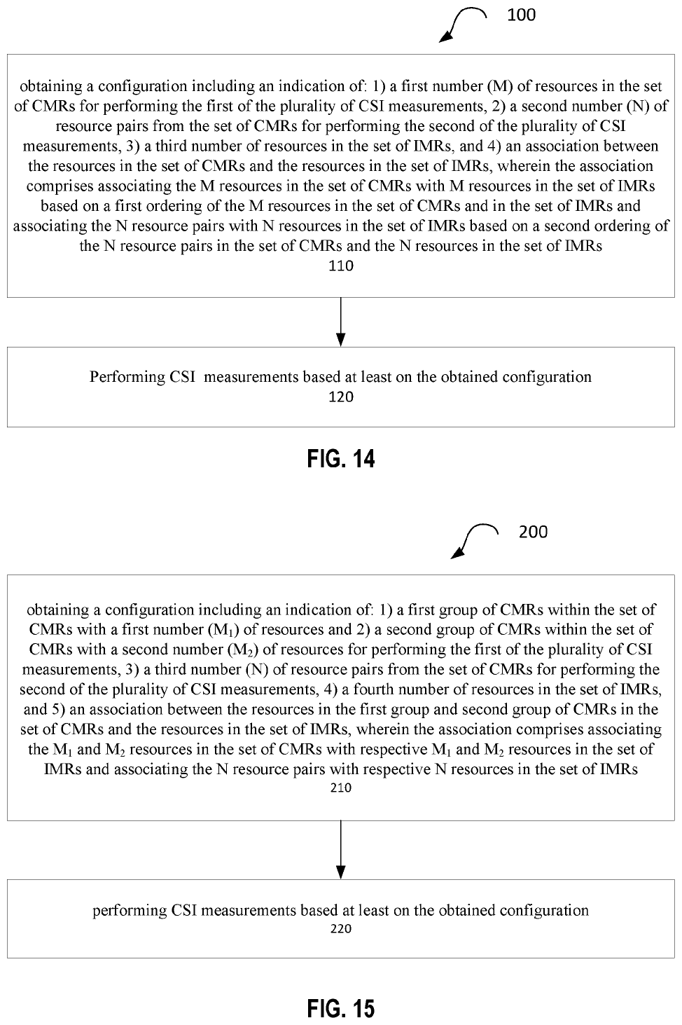

Now turning to FIG. 14, a flow chart of a method 100 in the UE for performing a plurality of measurements, such as NC-JT measurements (based on a pair of CSI-RS resources) and TRP measurements (based on a single CSI-RS resource), the UE being configured with a set of CMRs and a set of IMRs, will be described. The method 100 may comprise:

Step 110: obtaining a configuration including an indication of: 1) a first number (M) of resources in the set of CMRs for performing the first of the plurality of CSI measurements, 2) a second number (N) of resource pairs from the set of CMRs for performing the second of the plurality of CSI measurements, 3) a third number of resources in the set of IMRs, and 4) an association between the resources in the set of CMRs and the resources in the set of IMRs, wherein the association comprises associating the M resources in the set of CMRs with M resources in the set of IMRs based on a first ordering of the M resources in the set of CMRs and in the set of IMRs and associating the N resource pairs with N resources in the set of IMRs based on a second ordering of the N resource pairs in the set of CMRs and the N resources in the set of IMRs; and

Step 120: performing CSI measurements based at least on the obtained configuration.

For example, obtaining may comprise receiving a signal from the network node, the signal comprising the configuration. In some examples, the configuration can be given by the specification of the standard or hard-coded in the UE so that the UE obtains the configuration internally.

In some examples, the method 100 (or the UE) associates the first resource in the set of CMRs with the first resource in the set of IMRs and associate the second resource in the set of CMRs with the second resource in the set of IMRs and so on. In other words, resources in the set of CMRS are respectively associated with resources in the set of IMRs.

In some examples, the method or the UE associates a first resource pair from the set of CMRs to a (M+1)th resource in the set of IMRs and associating a second resource pair from the set of CMRs to a (M+2)th resource in the set of IMRs.

In some examples, the M resources in the set of CMRs can be separated into a first group and a second group (e.g. CMR group 0 and CMR group 1).

In some examples, a resource pair may comprise a first resource from the first group and a second resource from the second group.

In some examples, the third number of resources in the set of IMRs may comprise the sum of the first number and second number (M+N).

In some examples, the set of IMRs may comprise the same CSI-RS resources as in the set of the CMRS.

In some examples, the UE can send a CSI report to the network node, the CSI report comprising the CSI measurements.

Furthermore, the embodiments 1A and 1B are applicable to method 100.

Also, the UE of method 100 can receive a MAC CE as described in embodiments 2A and 2B.

FIG. 15 illustrates a flow chart of a method 200 in the UE for performing a plurality of measurements, such as NC-JT measurements (based on a pair of CSI-RS resources) and TRP measurements (based on a single CSI-RS resource), the UE being configured with a set of CMRs and a set of IMRs. The method 200 may comprise:

Step 210: obtaining a configuration including an indication of: 1) a first group of CMRs within the set of CMRs with a first number (M₁) of resources and 2) a second group of CMRS within the set of CMRs with a second number (M₂) of resources for performing the first of the plurality of CSI measurements, 3) a third number (N) of resource pairs from the set of CMRs for performing the second of the plurality of CSI measurements, 4) a fourth number of resources in the set of IMRs, and 5) an association between the resources in the first group and second group of CMRs in the set of CMRs and the resources in the set of IMRs, wherein the association comprises associating the M₁ and M₂ resources in the set of CMRs with respective M₁ and M₂ resources in the set of IMRs and associating the N resource pairs with respective N resources in the set of IMRs; and

Step 220: performing CSI measurements based at least on to the obtained configuration.

For example, the UE may obtain the configuration by receiving a signal from the network node, the signal comprising the configuration. In some examples, the configuration can be given by the specification of the standard or hard-coded in the UE so that the UE obtains the configuration internally.

In some examples, associating the M₁ and M₂ resources in the first group and second group of CMRs in the set of CMRs with M₁ and M₂ resources in the set of IMRs can be based on a first ordering of the M₁ and M₂ resources in the set of CMRs and in the set of IMRs. As an example, the UE associates the first resource in the M₁ and M₂ resources of the CMR set with the first resource in the IMR set and the second resource in the M₁ and M₂ resources of the CMR set with the second resource in the IMR set and so on.

In some examples, associating the N resource pairs with N resources in the set of IMRs can be based on a second ordering of the N resource pairs in the set of CMRs and the N resources in the set of IMRs. As an example, the UE can associates the first resource pair from the set of CMRs to a (M₁+M₂+1)th resource in the set of IMRs and associating a second resource pair from the set of CMRs to a (M₁+M₂+2)th resource in the set of IMRs.

In some examples, a resource pair can comprise a first resource from the first group and a second resource from the second group.

In some examples, the fourth number of resources in the set of IMRs can be the sum of the first number, second number and third number (M₁+M₂+N).

In some examples, the second number (M₂) may be implicitly given. For example, if the CMR set has M resources, and the first number M₁ is configured, then M₂ may be derived as M−M₁.

In some examples, the UE can send a CSI report to the network node, the CSI report comprising the CSI measurements.

Another method in the UE for performing NC-JT measurements and TRP measurements, with the UE being configured with a first set of measurement hypotheses (TRP), a second set of measurement hypotheses (NC-JT), and, a set of CMRs and a set of IMRs can comprise: receiving a signal from a network node, the signal indicating one measurement hypothesis from the first set to activate/deactivate; and performing measurements based on the indicated activation/deactivation of the measurement hypothesis. More details regarding this method can be found in the description of embodiments 2A and 2B.

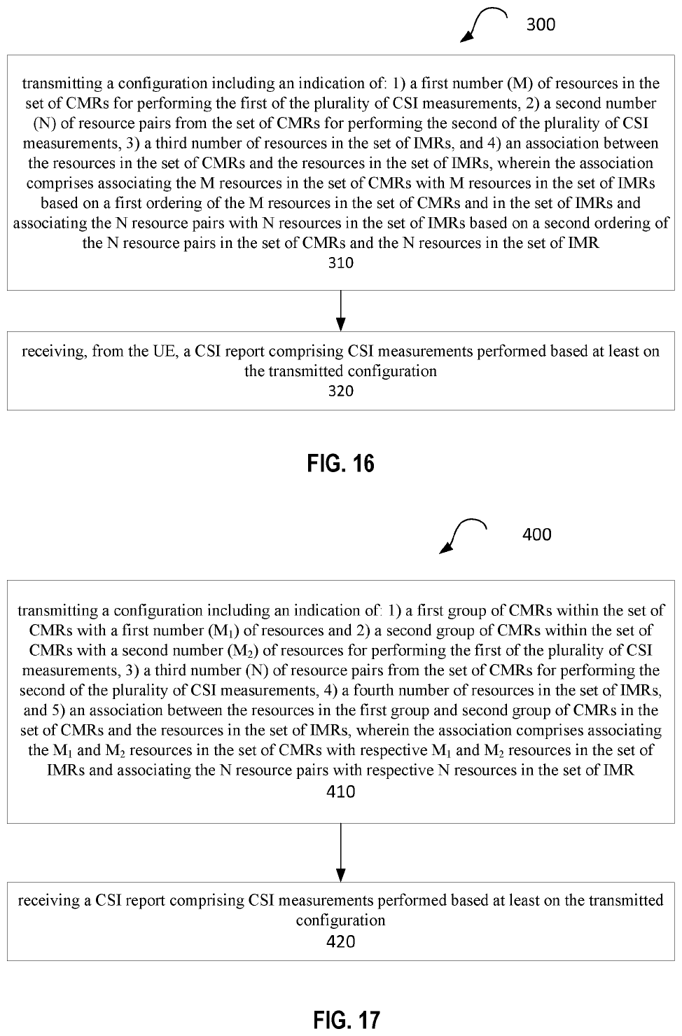

FIG. 16 illustrates a flow chart of an example of a method 300 in a network node for receiving a CSI report, from a UE, the CSI report comprising a plurality of CSI measurements, wherein at least a first of the plurality of CSI measurements is based on a single CSI-RS resource and at least a second of the plurality of CSI measurements is based on a pair of CSI-RS resources. The UE may be configured with a set of CMRs and a set of IMRs. Method 300 may comprise:

Step 310: transmitting a configuration including an indication of: 1) a first number (M) of resources in the set of CMRs for performing the first of the plurality of CSI measurements, 2) a second number (N) of resource pairs from the set of CMRs for performing the second of the plurality of CSI measurements, 3) a third number of resources in the set of IMRs, and 4) an association between the resources in the set of CMRs and the resources in the set of IMRs, wherein the association comprises associating the M resources in the set of CMRs with M resources in the set of IMRs based on a first ordering of the M resources in the set of CMRs and in the set of IMRs and associating the N resource pairs with N resources in the set of IMRs based on a second ordering of the N resource pairs in the set of CMRs and the N resources in the set of IMR; and

Step 320: receiving, from the UE, a CSI report comprising CSI measurements performed based at least on the transmitted configuration.

Similar examples as those related to method 100 can be applied to method 300.

FIG. 17 illustrates a flow chart of an example of another method 400 in a network node for receiving a CSI report, from a UE, the CSI report comprising a plurality of CSI measurements, wherein at least a first of the plurality of CSI measurements is based on a single CSI-RS resource and at least a second of the plurality of CSI measurements is based on a pair of CSI-RS resources. The UE may be configured with a set of CMRs and a set of IMRs. Method 400 comprises:

Step 410: transmitting a configuration including an indication of: 1) a first group of CMRs within the set of CMRs with a first number (M₁) of resources and 2) a second group of CMRs within the set of CMRs with a second number (M₂) of resources for performing the first of the plurality of CSI measurements, 3) a third number (N) of resource pairs from the set of CMRs for performing the second of the plurality of CSI measurements, 4) a fourth number of resources in the set of IMRs, and 5) an association between the resources in the first group and second group of CMRs in the set of CMRs and the resources in the set of IMRs, wherein the association comprises associating the M₁ and M₂ resources in the set of CMRs with respective M₁ and M₂ resources in the set of IMRs and associating the N resource pairs with respective N resources in the set of IMRs; and

Step 420: receiving a CSI report comprising CSI measurements performed based at least on to the transmitted configuration.

Similar examples as those related to method 200 can be applied to method 400.

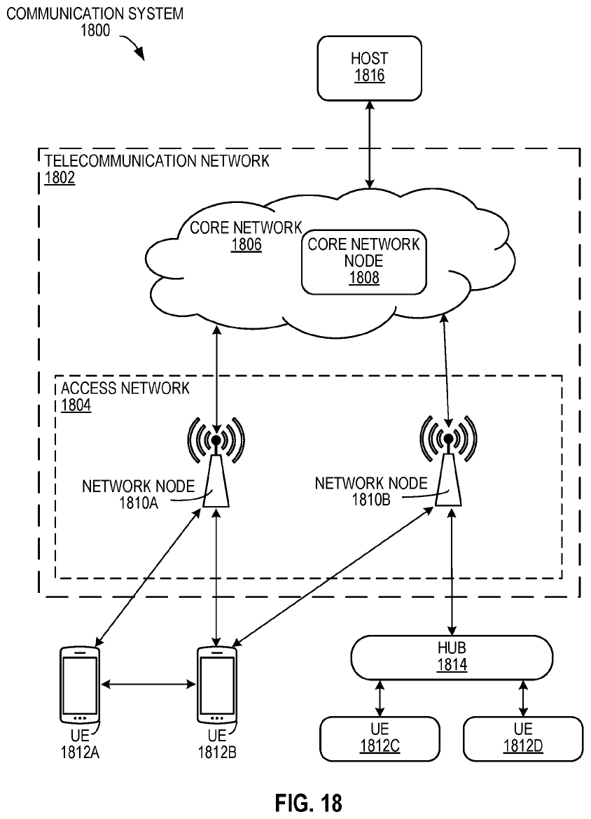

FIG. 18 shows an example of a communication system 1800 in accordance with some embodiments.

In the example, the communication system 1800 includes a telecommunication network 1802 that includes an access network 1804, such as a radio access network (RAN), and a core network 1806, which includes one or more core network nodes 1808. The access network 1804 includes one or more access network nodes, such as network nodes 1810a and 1810b (one or more of which may be generally referred to as network nodes 1810), or any other similar 3^{rd} Generation Partnership Project (3GPP) access node or non-3GPP access point. The network nodes 1810 facilitate direct or indirect connection of user equipment (UE), such as by connecting UEs 1812a, 1812b, 1812c, and 1812d (one or more of which may be generally referred to as UEs 1812) to the core network 1806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1800 may include any number of wired or wireless networks, network nodes, UEs, and/or any other components or systems that may facilitate or participate in the communication of data and/or signals whether via wired or wireless connections. The communication system 1800 may include and/or interface with any type of communication, telecommunication, data, cellular, radio network, and/or other similar type of system.

The UEs 1812 may be any of a wide variety of communication devices, including wireless devices arranged, configured, and/or operable to communicate wirelessly with the network nodes 1810 and other communication devices. Similarly, the network nodes 1810 are arranged, capable, configured, and/or operable to communicate directly or indirectly with the UEs 1812 and/or with other network nodes or equipment in the telecommunication network 1802 to enable and/or provide network access, such as wireless network access, and/or to perform other functions, such as administration in the telecommunication network 1802.

In FIG. 18, the core network 1806 connects the network nodes 1810 to one or more hosts, such as host 1816. These connections may be direct or indirect via one or more intermediary networks or devices. In other examples, network nodes may be directly coupled to hosts. The core network 1806 includes one more core network nodes (e.g., core network node 1808) that are structured with hardware and software components. Features of these components may be substantially similar to those described with respect to the UEs, network nodes, and/or hosts, such that the descriptions thereof are generally applicable to the corresponding components of the core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1816 may be under the ownership or control of a service provider other than an operator or provider of the access network 1804 and/or the telecommunication network 1802, and may be operated by the service provider or on behalf of the service provider. The host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1800 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); LTE and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1802 is a cellular network that implements 3GPP standardized features. Accordingly, the telecommunications network 1802 may support network slicing to provide different logical networks to different devices that are connected to the telecommunication network 1802. For example, the telecommunications network 1802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1812 are configured to transmit and/or receive information without direct human interaction. For instance, a UE may be designed to transmit information to the access network 1804 on a predetermined schedule, when triggered by an internal or external event, or in response to requests from the access network 1804. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1814 communicates with the access network 1804 to facilitate indirect communication between one or more UEs (e.g., UE 1812c and/or 1812d) and network nodes (e.g., network node 1810b). In some examples, the hub 1814 may be a controller, router, content source and analytics, or any of the other communication devices described herein regarding UEs. For example, the hub 1814 may be a broadband router enabling access to the core network 1806 for the UEs. As another example, the hub 1814 may be a controller that sends commands or instructions to one or more actuators in the UEs. Commands or instructions may be received from the UEs, network nodes 1810, or by executable code, script, process, or other instructions in the hub 1814. As another example, the hub 1814 may be a data collector that acts as temporary storage for UE data and, in some embodiments, may perform analysis or other processing of the data. As another example, the hub 1814 may be a content source. For example, for a UE that is a VR headset, display, loudspeaker or other media delivery device, the hub 1814 may retrieve VR assets, video, audio, or other media or data related to sensory information via a network node, which the hub 1814 then provides to the UE either directly, after performing local processing, and/or after adding additional local content. In still another example, the hub 1814 acts as a proxy server or orchestrator for the UEs, in particular in if one or more of the UEs are low energy IoT devices.

The hub 1814 may have a constant/persistent or intermittent connection to the network node 1810b. The hub 1814 may also allow for a different communication scheme and/or schedule between the hub 1814 and UEs (e.g., UE 1812c and/or 1812d), and between the hub 1814 and the core network 1806. In other examples, the hub 1814 is connected to the core network 1806 and/or one or more UEs via a wired connection. Moreover, the hub 1814 may be configured to connect to an M₂M service provider over the access network 1804 and/or to another UE over a direct connection. In some scenarios, UEs may establish a wireless connection with the network nodes 1810 while still connected via the hub 1814 via a wired or wireless connection. In some embodiments, the hub 1814 may be a dedicated hub—that is, a hub whose primary function is to route communications to/from the UEs from/to the network node 1810b. In other embodiments, the hub 1814 may be a non-dedicated hub—that is, a device which is capable of operating to route communications between the UEs and network node 1810b, but which is additionally capable of operating as a communication start and/or end point for certain data channels.

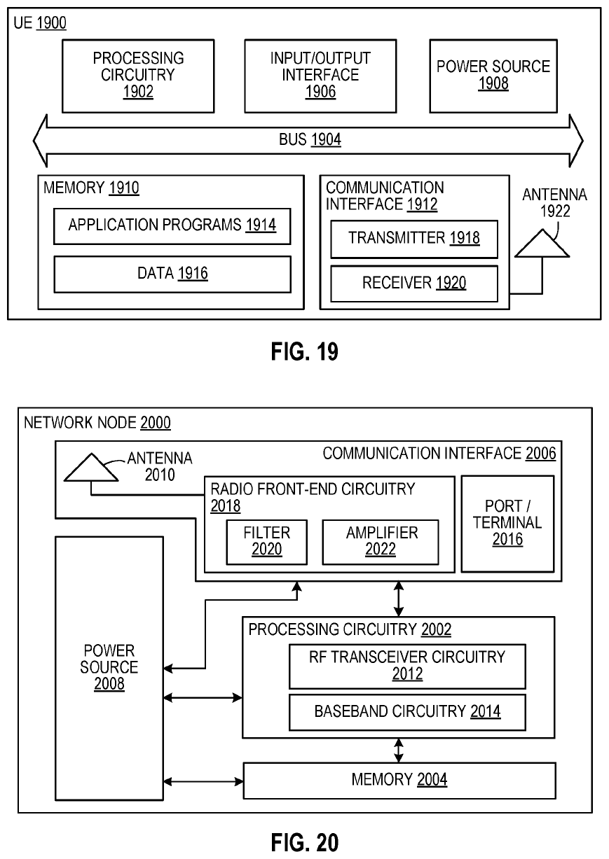

FIG. 19 shows a UE 1900 according to some embodiments. A UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X).

The UE 1900 includes processing circuitry 1902 that is operatively coupled via a bus 1904 to an input/output interface 1906, a power source 1908, a memory 1910, a communication interface 1912, and/or any other component, or any combination thereof. Certain UEs may utilize all or a subset of the components shown in FIG. 19. Certain UEs may contain multiple instances of a component, such as multiple processors, memories, transceivers, transmitters, receivers, etc.

The processing circuitry 1902 is configured to process instructions and data and may be configured to implement any sequential state machine operative to execute instructions stored as machine-readable computer programs in the memory 1910. The processing circuitry 1902 may be implemented as one or more hardware-implemented state machines (e.g., in discrete logic, field-programmable gate arrays (FPGAs), application specific integrated circuits (ASICs), etc.); programmable logic with appropriate firmware; one or more stored computer programs, general-purpose processors, such as a microprocessor or digital signal processor (DSP), together with appropriate software; or any combination of the above. For example, the processing circuitry 1902 may include multiple central processing units (CPUs). The processing circuitry 1902 is configured to perform any steps/blocks/operations of method 100 of FIG. 14 and method 200 of FIG. 15.

In the example, the input/output interface 1906 may be configured to provide an interface or interfaces to an input device, output device, or one or more input and/or output devices. An input device may allow a user to capture information into the UE 1900.

In some embodiments, the power source 1908 is structured as a battery or battery pack. Other types of power sources, such as an external power source (e.g., an electricity outlet), photovoltaic device, or power cell, may be used. The power source 1908 may further include power circuitry for delivering power from the power source 1908 itself, and/or an external power source, to the various parts of the UE 1900 via input circuitry or an interface such as an electrical power cable.

The memory 1910 may be or be configured to include memory such as random access memory (RAM), read-only memory (ROM), programmable ROM (PROM), erasable PROM (EPROM), electrically EPROM (EEPROM), magnetic disks, optical disks, hard disks, removable cartridges, flash drives, etc. In one example, the memory 1910 includes one or more application programs 1914, such as an operating system, web browser application, a widget, gadget engine, or other application, and corresponding data 1916. The memory 1910 may store, for use by the UE 1900, any of a variety of various operating systems or combinations of operating systems.

The memory 1910 may be configured to include a number of physical drive units, such as redundant array of independent disks, flash memory, USB flash drive, external hard disk drive, thumb drive, pen drive, key drive, high-density digital versatile disc optical disc drive, internal hard disk drive, Blu-Ray optical disc drive, holographic digital data storage optical disc drive, external mini-dual in-line memory module, synchronous dynamic random access memory (SDRAM), external micro-DIMM SDRAM, smartcard memory such as tamper resistant module in the form of a universal integrated circuit card including one or more subscriber identity modules (SIMs), such as a USIM and/or ISIM, other memory, or any combination thereof. The memory 1910 may allow the UE 1900 to access instructions, application programs and the like, stored on transitory or non-transitory memory media, to off-load data, or to upload data. An article of manufacture, such as one utilizing a communication system may be tangibly embodied as or in the memory 1910, which may be or comprise a device-readable storage medium.

The processing circuitry 1902 may be configured to communicate with an access network or other network using the communication interface 1912. The communication interface 1912 may comprise one or more communication subsystems and may include or be communicatively coupled to an antenna 1922. The communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, the transmitter 1918 and receiver 1920 may be coupled to one or more antennas (e.g., antenna 1922) and may share circuit components, software or firmware, or alternatively be implemented separately.

Communication functions of the communication interface 1912 may include cellular, Wi-Fi, LPWAN, data, voice, multimedia, short-range (e.g. Bluetooth, near-field, GPS) communications or any combination thereof. Communications may be implemented according to one or more communication protocols and/or standards, such as IEEE 802.11, CDMA, WCDMA, GSM, LTE, NR, UMTS, WiMax, Ethernet, TCP/IP, etc.

Regardless of the type of sensor, a UE may provide an output of data captured by its sensors, through its communication interface 1912, via a wireless connection to a network node.

A UE in the form of an IoT device comprises circuitry and/or software in dependence of the intended application of the IoT device in addition to other components as described in relation to the UE 1900 shown in FIG. 19.

As another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device.

In practice, any number of UEs may be used together with respect to a single use case, e.g., a first UE might be or be integrated in a drone and provide the drone's speed information (obtained through a speed sensor) to a second UE that is a remote controller operating the drone.

FIG. 20 shows a network node 2000 in accordance with some embodiments. A network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, NBs, eNBs and NR gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multi-TRP 5G access nodes, multi-standard radio (MSR) equipment such as MSR BSs, network controllers (e.g. RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), etc.

The network node 2000 includes a processing circuitry 2002, a memory 2004, a communication interface 2006, and a power source 2008. The network node 2000 may be composed of multiple physically separate components (e.g., a NB component and a RNC component, or a BTS component and a BSC component, etc.), which may each have their own respective components. In some embodiments, the network node 2000 may be configured to support multiple radio access technologies (RATs). In such embodiments, some components may be duplicated (e.g., separate memory 2004 for different RATs) and some components may be reused (e.g., a same antenna 2010 may be shared by different RATs). The network node 2000 may also include multiple sets of the various illustrated components for different wireless technologies integrated into network node 2000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2000.

The processing circuitry 2002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2000 components, such as the memory 2004, to provide network node 2000 functionality.

In some embodiments, the processing circuitry 2002 includes a system on a chip (SOC). In some embodiments, the processing circuitry 2002 includes one or more of radio frequency (RF) transceiver circuitry 2012 and baseband processing circuitry 2014. In some embodiments, the RF transceiver circuitry 2012 and the baseband processing circuitry 2014 may be on separate chips (or sets of chips), boards, or units, such as radio units and digital units. In alternative embodiments, part or all of RF transceiver circuitry 2012 and baseband processing circuitry 2014 may be on the same chip or set of chips, boards, or units.

The memory 2004 may comprise any form of volatile or non-volatile computer-readable memory including, without limitation, persistent storage, solid-state memory, remotely mounted memory, magnetic media, optical media, RAM, ROM, mass storage media (e.g., a hard disk), removable storage media (for example, a flash drive, a Compact Disk or a Digital Video Disk, and/or any other volatile or non-volatile, non-transitory device-readable and/or computer-executable memory devices that store information, data, and/or instructions that may be used by the processing circuitry 2002. The memory 2004 may store any suitable instructions, data, or information, including a computer program, software, an application including one or more of logic, rules, code, tables, and/or other instructions capable of being executed by the processing circuitry 2002 and utilized by the network node 2000. The memory 2004 may be used to store any calculations made by the processing circuitry 2002 and/or any data received via the communication interface 2006. In some embodiments, the processing circuitry 2002 and memory 2004 is integrated. Furthermore, the processing circuitry 2002 is configured to perform any steps/blocks/operations of method 300 of FIG. 17 and method 400 of FIG. 17.

The communication interface 2006 is used in wired or wireless communication of signaling and/or data between a network node, access network, and/or UE. As illustrated, the communication interface 2006 comprises port(s)/terminal(s) 2016 to send and receive data, for example to and from a network over a wired connection. The communication interface 2006 also includes radio front-end circuitry 2018 that may be coupled to, or in certain embodiments a part of, the antenna 2010. Radio front-end circuitry 2018 comprises filters 2020 and amplifiers 2022. The radio front-end circuitry 2018 may be connected to an antenna 2010 and processing circuitry 2002. The radio front-end circuitry may be configured to condition signals communicated between antenna 2010 and processing circuitry 2002. The radio front-end circuitry 2018 may receive digital data that is to be sent out to other network nodes or UEs via a wireless connection. The radio front-end circuitry 2018 may convert the digital data into a radio signal having the appropriate channel and bandwidth parameters using a combination of filters 2020 and/or amplifiers 2022. The radio signal may then be transmitted via the antenna 2010. Similarly, when receiving data, the antenna 2010 may collect radio signals which are then converted into digital data by the radio front-end circuitry 2018. The digital data may be passed to the processing circuitry 2002. In other embodiments, the communication interface may comprise different components and/or different combinations of components.

In certain alternative embodiments, the network node 2000 does not include separate radio front-end circuitry 2018, instead, the processing circuitry 2002 includes radio front-end circuitry and is connected to the antenna 2010. Similarly, in some embodiments, all or some of the RF transceiver circuitry 2012 is part of the communication interface 2006. In still other embodiments, the communication interface 2006 includes one or more ports or terminals 2016, the radio front-end circuitry 2018, and the RF transceiver circuitry 2012, as part of a radio unit (not shown), and the communication interface 2006 communicates with the baseband processing circuitry 2014, which is part of a digital unit (not shown).

The antenna 2010 may include one or more antennas, or antenna arrays, configured to send and/or receive wireless signals. The antenna 2010 may be coupled to the radio front-end circuitry 2018 and may be any type of antenna capable of transmitting and receiving data and/or signals wirelessly. In certain embodiments, the antenna 2010 is separate from the network node 2000 and connectable to the network node 2000 through an interface or port.

The antenna 2010, communication interface 2006, and/or the processing circuitry 2002 may be configured to perform any receiving operations and/or certain obtaining operations described herein as being performed by the network node. Any information, data and/or signals may be received from a UE, another network node and/or any other network equipment. Similarly, the antenna 2010, the communication interface 2006, and/or the processing circuitry 2002 may be configured to perform any transmitting operations described herein as being performed by the network node. Any information, data and/or signals may be transmitted to a UE, another network node and/or any other network equipment.

The power source 2008 provides power to the various components of network node 2000 in a form suitable for the respective components (e.g., at a voltage and current level needed for each respective component). The power source 2008 may further comprise, or be coupled to, power management circuitry to supply the components of the network node 2000 with power for performing the functionality described herein. For example, the network node 2000 may be connectable to an external power source (e.g., the power grid, an electricity outlet) via an input circuitry or interface such as an electrical cable, whereby the external power source supplies power to power circuitry of the power source 2008. As an example, the power source 2008 may comprise a source of power in the form of a battery or battery pack which is connected to, or integrated in, power circuitry. The battery may provide backup power should the external power source fail.

Embodiments of the network node 2000 may include additional components beyond those shown in FIG. 20 for providing certain aspects of the network node's functionality, including any of the functionality described herein and/or any functionality necessary to support the subject matter described herein. For example, the network node 2000 may include user interface equipment to allow input of information into the network node 2000 and to allow output of information from the network node 2000. This may allow a user to perform diagnostic, maintenance, repair, and other administrative functions for the network node 2000.

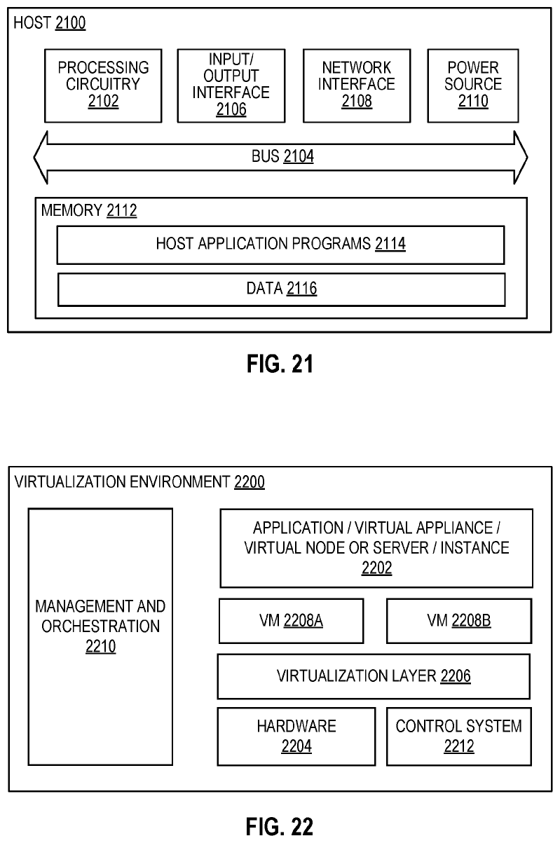

FIG. 21 is a block diagram of a host 2100, which may be an embodiment of the host 1816 of FIG. 18, in accordance with various aspects described herein. As used herein, the host 2100 may be or comprise various combinations hardware and/or software, including a standalone server, a blade server, a cloud-implemented server, a distributed server, a virtual machine, container, or processing resources in a server farm. The host 2100 may provide one or more services to one or more UEs.

The host 2100 includes processing circuitry 2102 that is operatively coupled via a bus 2104 to an input/output interface 2106, a network interface 2108, a power source 2110, and a memory 2112. Other components may be included in other embodiments. Features of these components may be substantially similar to those described with respect to the devices of previous figures, such as FIGS. 19 and 20, such that the descriptions thereof are generally applicable to the corresponding components of host 2100.

The memory 2112 may include one or more computer programs including one or more host application programs 2114 and data 2116, which may include user data, e.g., data generated by a UE for the host 2100 or data generated by the host 2100 for a UE. Embodiments of the host 2100 may utilize only a subset or all of the components shown. The host application programs 2114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2114 may also provide for user authentication and licensing checks and may periodically report health, routes, and content availability to a central node, such as a device in or on the edge of a core network. Accordingly, the host 2100 may select and/or indicate a different host for over-the-top services for a UE. The host application programs 2114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 22 is a block diagram illustrating a virtualization environment 2200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2206 (also referred to as hypervisors or virtual machine monitors (VMMs)), provide VMs 2208a and 2208b (one or more of which may be generally referred to as VMs 2208), and/or perform any of the functions, features and/or benefits described in relation with some embodiments described herein. The virtualization layer 2206 may present a virtual operating platform that appears like networking hardware to the VMs 2208.

The VMs 2208 comprise virtual processing, virtual memory, virtual networking or interface and virtual storage, and may be run by a corresponding virtualization layer 2206. Different embodiments of the instance of a virtual appliance 2202 may be implemented on one or more of VMs 2208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2208 may be a software implementation of a physical machine that runs programs as if they were executing on a physical, non-virtualized machine. Each of the VMs 2208, and that part of hardware 2204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2208 on top of the hardware 2204 and corresponds to the application 2202.

Hardware 2204 may be implemented in a standalone network node with generic or specific components. Hardware 2204 may implement some functions via virtualization. Alternatively, hardware 2204 may be part of a larger cluster of hardware (e.g. such as in a data center or CPE) where many hardware nodes work together and are managed via management and orchestration 2210, which, among others, oversees lifecycle management of applications 2202. In some embodiments, hardware 2204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2212 which may alternatively be used for communication between hardware nodes and radio units.

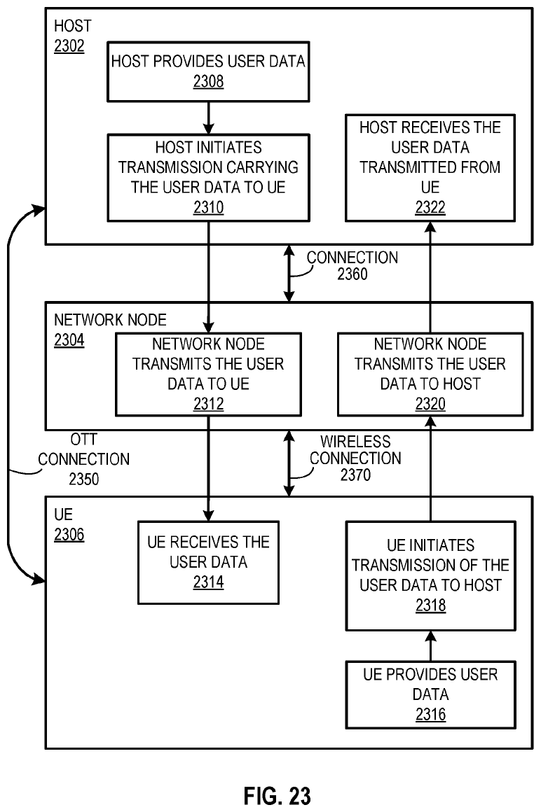

FIG. 23 shows a communication diagram of a host 2302 communicating via a network node 2304 with a UE 2306 over a partially wireless connection in accordance with some embodiments. Example implementations, in accordance with various embodiments, of the UE (such as a UE 1812a of FIG. 18 and/or UE 1900 of FIG. 19), network node (such as network node 1810a of FIG. 18 and/or network node 2000 of FIG. 20), and host (such as host 1816 of FIG. 18 and/or host 2100 of FIG. 21) discussed in the preceding paragraphs will now be described with reference to FIG. 23.

Like host 2100, embodiments of host 2302 include hardware, such as a communication interface, processing circuitry, and memory. The host 2302 also includes software, which is stored in or accessible by the host 2302 and executable by the processing circuitry. The software includes a host application that may be operable to provide a service to a remote user, such as the UE 2306 connecting via an over-the-top (OTT) connection 2350 extending between the UE 2306 and host 2302. In providing the service to the remote user, a host application may provide user data which is transmitted using the OTT connection 2350.

The network node 2304 includes hardware enabling it to communicate with the host 2302 and UE 2306. The connection 2360 may be direct or pass through a core network (like core network 1806 of FIG. 18) and/or one or more other intermediate networks, such as one or more public, private, or hosted networks. For example, an intermediate network may be a backbone network or the Internet.

The UE 2306 includes hardware and software, which is stored in or accessible by UE 2306 and executable by the UE's processing circuitry. The software includes a client application, such as a web browser or operator-specific “app” that may be operable to provide a service to a human or non-human user via UE 2306 with the support of the host 2302. In the host 2302, an executing host application may communicate with the executing client application via the OTT connection 2350 terminating at the UE 2306 and host 2302. In providing the service to the user, the UE's client application may receive request data from the host's host application and provide user data in response to the request data. The OTT connection 2350 may transfer both the request data and the user data. The UE's client application may interact with the user to generate the user data that it provides to the host application through the OTT connection 2350.

The OTT connection 2350 may extend via a connection 2360 between the host 2302 and the network node 2304 and via a wireless connection 2370 between the network node 2304 and the UE 2306 to provide the connection between the host 2302 and the UE 2306. The connection 2360 and wireless connection 2370, over which the OTT connection 2350 may be provided, have been drawn abstractly to illustrate the communication between the host 2302 and the UE 2306 via the network node 2304, without explicit reference to any intermediary devices and the precise routing of messages via these devices.

As an example of transmitting data via the OTT connection 2350, in step 2308, the host 2302 provides user data, which may be performed by executing a host application. In some embodiments, the user data is associated with a particular human user interacting with the UE 2306. In other embodiments, the user data is associated with a UE 2306 that shares data with the host 2302 without explicit human interaction. In step 2310, the host 2302 initiates a transmission carrying the user data towards the UE 2306. The host 2302 may initiate the transmission responsive to a request transmitted by the UE 2306. The request may be caused by human interaction with the UE 2306 or by operation of the client application executing on the UE 2306. The transmission may pass via the network node 2304, in accordance with the teachings of the embodiments described throughout this disclosure. Accordingly, in step 2312, the network node 2304 transmits to the UE 2306 the user data that was carried in the transmission that the host 2302 initiated, in accordance with the teachings of the embodiments described throughout this disclosure. In step 2314, the UE 2306 receives the user data carried in the transmission, which may be performed by a client application executed on the UE 2306 associated with the host application executed by the host 2302.

In some examples, the UE 2306 executes a client application which provides user data to the host 2302. The user data may be provided in reaction or response to the data received from the host 2302. Accordingly, in step 2316, the UE 2306 may provide user data, which may be performed by executing the client application. In providing the user data, the client application may further consider user input received from the user via an input/output interface of the UE 2306. Regardless of the specific manner in which the user data was provided, the UE 2306 initiates, in step 2318, transmission of the user data towards the host 2302 via the network node 2304. In step 2320, in accordance with the teachings of the embodiments described throughout this disclosure, the network node 2304 receives user data from the UE 2306 and initiates transmission of the received user data towards the host 2302. In step 2322, the host 2302 receives the user data carried in the transmission initiated by the UE 2306.

One or more of the various embodiments improve the performance of OTT services provided to the UE 2306 using the OTT connection 2350, in which the wireless connection 2370 forms the last segment. More precisely, the teachings of these embodiments may improve the data rate, latency and power consumption and thereby provide benefits such as, e.g., reduced user waiting time, better responsiveness, extended battery lifetime.

In an example scenario, factory status information may be collected and analyzed by the host 2302. As another example, the host 2302 may process audio and video data which may have been retrieved from a UE for use in creating maps. As another example, the host 2302 may collect and analyze real-time data to assist in controlling vehicle congestion (e.g., controlling traffic lights). As another example, the host 2302 may store surveillance video uploaded by a UE. As another example, the host 2302 may store or control access to media content such as video, audio, VR or AR which it can broadcast, multicast or unicast to UEs. As other examples, the host 2302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2350 between the host 2302 and UE 2306, in response to variations in the measurement results. The measurement procedure and/or the network functionality for reconfiguring the OTT connection may be implemented in software and hardware of the host 2302 and/or UE 2306. In some embodiments, sensors (not shown) may be deployed in or in association with other devices through which the OTT connection 2350 passes; the sensors may participate in the measurement procedure by supplying values of the monitored quantities exemplified above, or supplying values of other physical quantities from which software may compute or estimate the monitored quantities. The reconfiguring of the OTT connection 2350 may include message format, retransmission settings, preferred routing etc.; the reconfiguring need not directly alter the operation of the network node 2304. Such procedures and functionalities may be known and practiced in the art. In certain embodiments, measurements may involve proprietary UE signaling that facilitates measurements of throughput, propagation times, latency and the like, by the host 2302. The measurements may be implemented in that software causes messages to be transmitted, in particular empty or ‘dummy’ messages, using the OTT connection 2350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description, which is defined solely by the appended claims.

1. A method performed by a user equipment (UE) for performing a plurality of Channel State Information (CSI) measurements for CSI reporting, wherein at least a first of the plurality of CSI measurements is based on a single CSI-Reference signal (RS) resource and at least a second of the plurality of CSI measurements is based on a pair of CSI-RS resources, the UE being configured with a set of Channel Measurement Resources (CMRs) and a set of Interference Measurement Resources (IMRs), the method comprising:
obtaining a configuration including an indication of:
a first number (M) of resources in the set of CMRs for performing the first of the plurality of CSI measurements,
a second number (N) of resource pairs from the set of CMRs for performing the second of the plurality of CSI measurements,
a third number of resources in the set of IMRs, wherein the third number of resources in the set of IMRs is the sum of the first number and second number (M+N),
an association between the resources in the set of CMRs and the resources in the set of IMRs, wherein the association comprises associating the M resources in the set of CMRs with M resources in the set of IMRs based on a first ordering of the M resources in the set of CMRs and in the set of IMRs and associating the N resource pairs with N resources in the set of IMRs based on a second ordering of the N resource pairs in the set of CMRs and the N resources in the set of IMRs; and
performing CSI measurements based at least on the obtained configuration.

2. The method of claim 1, wherein obtaining the configuration comprises receiving a signal from a network node, the signal comprising the configuration.

3. The method of claim 1, wherein associating the M resources in the set of CMRs with M resources in the set of IMRs based on a first ordering of the M resources in the set of CMRs and in the set of IMRs comprises associating a first resource in the set of CMRs with a first resource in the set of IMRs and associating a second resource in the set of CMRs with a second resource in the set of IMRs.

4. The method of claim 1, wherein associating the N resource pairs with N resources in the set of IMRs based on a second ordering of the N resource pairs from the set of CMRs and the N resources in the set of IMRs comprises associating a first resource pair from the set of CMRs to a (M+1)th resource in the set of IMRs and associating a second resource pair from the set of CMRs to a (M+2)th resource in the set of IMRs.

5. The method of claim 1, wherein the M resources in the set of CMRs are separated into a first group and a second group.

6. The method of claim 5, wherein a resource pair comprises a first resource from the first group and a second resource from the second group.

7. The method of claim 1, wherein the set of IMRs comprises the same CSI-RS resources as those in the set of the CMRs.

8. A method in a network node for receiving a channel state information (CSI) report, from a User Equipment (UE), the CSI report comprising a plurality of CSI measurements, wherein at least a first of the plurality of CSI measurements is based on a single CSI-Reference Signal (RS) resource and at least a second of the plurality of CSI measurements is based on a pair of CSI-RS resources, the method comprising:
transmitting a configuration including an indication of:
a first number (M) of resources in a set of Channel Measurement Resources (CMRs) for performing the first of the plurality of CSI measurements,
a second number (N) of resource pairs from the set of CMRs for performing the second of the plurality of CSI measurements,
a third number of resources in a set of Interference Measurement Resources (IMRs), wherein the third number of resources in the set of IMRs is the sum of the first number and second number (M+N),
an association between the resources in the set of CMRs and the resources in the set of IMRs, wherein the association comprises associating the M resources in the set of CMRs with M resources in the set of IMRs based on a first ordering of the M resources in the set of CMRs and in the set of IMRs and associating the N resource pairs with N resources in the set of IMRs based on a second ordering of the N resource pairs in the set of CMRs and the N resources in the set of IMRs; and
receiving from the UE a CSI report comprising CSI measurements based at least on the transmitted configuration.

9. The method of claim 8, wherein associating the M resources in the set of CMRs with M resources in the set of IMRs based on a first ordering of the M resources in the set of CMRs and in the set of IMRs comprises associating a first resource in the set of CMRs with a first resource in the set of IMRs and associating a second resource in the set of CMRs with a second resource in the set of IMRs.

10. The method of claim 8, wherein associating the N resource pairs with N resources in the set of IMRs based on a second ordering of the N resource pairs from the set of CMRs and the N resources in the set of IMRs comprises associating a first resource pair from the set of CMRs to a (M+1)th resource in the set of IMRs and associating a second resource pair from the set of CMRs to a (M+2)th resource in the set of IMRs.

11. The method of claim 8, wherein the M resources in the set of CMRs are separated into a first group and a second group.

12. The method of claim 11, wherein a resource pair comprises a first resource from the first group and a second resource from the second group.

13. The method of claim 8, wherein the set of IMRs comprises the same CSI-RS resources as those in the set of the CMRs.

14. The method of claim 8, wherein the third number of resources in the set of IMRs is the sum of the first number and second number (M+N).

15-29. (canceled)

30. A User Equipment (UE) comprising a network interface and processing circuitry connected thereto, the processing circuitry configured to:
obtain a configuration including an indication of:
a first number (M) of resources in the set of CMRs for performing the first of the plurality of CSI measurements,
a second number (N) of resource pairs from the set of CMRs for performing the second of the plurality of CSI measurements,
a third number of resources in the set of IMRs, wherein the third number of resources in the set of IMRs is the sum of the first number and second number (M+N),
an association between the resources in the set of CMRs and the resources in the set of IMRs, wherein the association comprises associating the M resources in the set of CMRs with M resources in the set of IMRs based on a first ordering of the M resources in the set of CMRs and in the set of IMRs and associating the N resource pairs with N resources in the set of IMRs based on a second ordering of the N resource pairs in the set of CMRs and the N resources in the set of IMRs; and
perform CSI measurements based at least on the obtained configuration.

31. (canceled)

32. The UE of claim 30, wherein the processing circuitry is further configured to obtain the configuration by receiving a signal from a network node, the signal comprising the configuration.

33. The UE of claim 30, wherein the processing circuitry is further configured to associate the M resources in the set of CMRs with M resources in the set of IMRs based on a first ordering of the M resources in the set of CMRs and in the set of IMRs by associating a first resource in the set of CMRs with a first resource in the set of IMRs and associating a second resource in the set of CMRs with a second resource in the set of IMRs.

34. The UE of claim 30, wherein the processing circuitry is further configured to associate the N resource pairs with N resources in the set of IMRs based on a second ordering of the N resource pairs from the set of CMRs and the N resources in the set of IMRs by associating a first resource pair from the set of CMRs to a (M+1)th resource in the set of IMRs and associating a second resource pair from the set of CMRs to a (M+2)th resource in the set of IMRs.

35. The method of claim 30, wherein the M resources in the set of CMRs are separated into a first group and a second group.

36. The method of claim 35, wherein a resource pair comprises a first resource from the first group and a second resource from the second group.
